(19) United States
(12) Patent Application Publication
(10) Pub. No.: US 2026/0053193 A1
(43) Pub. Date: Feb. 26, 2026

(54) AEROSOL GENERATING DEVICE

(71) Applicant: KT&G CORPORATION, Daejeon (KR)

(72) Inventors: Won Kyeong LEE, Guri-si (KR); Sang Cheol PARK, Suwon-si (KR); Chul Ho JANG, Bucheon-si (KR)

(73) Assignee: KT&G CORPORATION, Daejeon (KR)

(21) Appl. No.: 19/278,950

(22) Filed: Jul. 24, 2025

(30) Foreign Application Priority Data
Aug. 20, 2024 (KR) 10-2024-0111630

(51) Int. Cl. A24F 40/46

(52) U.S. Cl. CPC A24F 40/46

(57) ABSTRACT

An aerosol generating device includes a housing comprising an insertion space for accommodating an aerosol generating article, one or more heaters configured to heat the aerosol generating article inserted into the insertion space, and a deformation portion configured to deform in response to a temperature change caused by the one or more heaters, wherein heating areas of the one or more heaters for the aerosol generating article vary depending on deformation of the deformation portion.

### CROSS-REFERENCE TO RELATED APPLICATION

This application is based on and claims priority under 35 U.S.C. § 119 to Korean Patent Application No. 10-2024-0111630, filed on Aug. 20, 2024, in the Korean Intellectual Property Office, the disclosure of which is incorporated by reference herein in its entirety.

### BACKGROUND

### 1. Field

Various embodiments of the disclosure relate to an aerosol generating device, and more particularly, to an aerosol generating device in which an area of an aerosol generating article that is heated changes over time after the start of heating.

### 2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted.

To heat the cigarette or aerosol generating material, a heater may be placed in the aerosol generating device. The heater may heat the medium of the cigarette or the aerosol generating material to generate an aerosol.

Various devices or apparatuses may be placed around the heater that emits heat. For example, a sensor may be placed to measure the temperature of the heater. In addition, an insulating structure may be placed so that the heat of the heater is not transmitted to the user. In addition, a device that may utilize a change in the temperature of the heater may be placed.

An example of a device that utilizes a change in the temperature of the heater is a bimetal. The bimetal is an object in which two different types of metals are joined in a superimposed state, and is a device that converts a temperature change into a mechanical length and position change. When heat is applied to the bimetal, the two different types of metals have different elongation lengths due to a difference in thermal expansion coefficients, and thus, the bimetal may bend toward a metal with a smaller thermal expansion coefficient. Conversely, when the bimetal is cooled below a reference temperature, the bimetal bends toward a metal with a larger thermal expansion coefficient. Most metals have good ductility, and thus may easily bend.

A commonly used bimetal has a structure in which two pieces of bar are joined, but in addition, the bimetal may have a coil-shaped structure. Because the bimetal having the coil-shaped structure has a long length, the bimetal may induce a larger change in length with temperature change.

### SUMMARY

While the user is using an aerosol generating device, an aerosol generating article (herein, ‘cigarette’ or ‘stick’ may be used interchangeably with the aerosol generating article) generally does not move with respect to a heater. Likewise, the heater does not move with respect to the aerosol generating article, and heats the medium of the aerosol generating article at a fixed location inside the aerosol generating device.

When heat generated from the heater is transferred to the medium, the heat spreads from a contact portion with the heater to the entire area of the medium. When the entire area of the medium is heated at the same time, a large amount of aerosol may be generated in a short period of time.

When the heat generated from the heater is quickly transferred to the entire area of the medium, a large amount of aerosol may be supplied to the user at the beginning of the use of the aerosol generating device. In this case, relatively less aerosol is generated at the end of the use of the aerosol generating device, and as a result, the amount of aerosol supplied to the user is small, which may decrease the user's satisfaction with smoking.

In order to solve this problem, it is necessary to uniformly generate aerosol during the time the user uses the aerosol generating device by preventing the entire area of the medium from being heated in a short period of time.

Embodiments provide an aerosol generating device capable of controlling a heater so that the heating area of an aerosol generating article increases over time while heating the aerosol generating article.

Embodiments also provide an aerosol generating device capable of controlling a heater so that an area of the aerosol generating article that is heated changes over time while heating the aerosol generating article.

Embodiments also provide an aerosol generating device capable of controlling a heater so that the number of heaters to which power is supplied gradually increases while heating the aerosol generating article.

The technical problems of the present disclosure are not limited to the above-described description, and other technical problems may be clearly understood by one of ordinary skill in the art from the embodiments to be described hereinafter.

Additional aspects will be set forth in part in the description which follows and, in part, will be apparent from the description, or may be learned by practice of the presented embodiments of the disclosure.

An aerosol generating device according to an embodiment may include a housing comprising an insertion space for accommodating an aerosol generating article, one or more heaters configured to heat the aerosol generating article inserted into the insertion space, and a deformation portion configured to deform in response to a temperature change caused by the one or more heaters, wherein heating areas of the one or more heaters for the aerosol generating article may vary depending on deformation of the deformation portion.

An aerosol generating device according to another embodiment may include a housing comprising an insertion space for accommodating an aerosol generating article, one or more heaters configured to heat the aerosol generating article inserted into the insertion space, and a deformation portion configured to deform in response to a temperature change caused by the one or more heaters, wherein the one or more heaters may move according to the deformation of the deformation portion, and thus, an area of the aerosol generating article that is heated may change.

An aerosol generating device according to another embodiment may include a housing comprising an insertion space for accommodating an aerosol generating article, a plurality of heaters configured to heat the aerosol generating article inserted into the insertion space, and a first deformation portion configured to deform in response to a temperature change caused by at least one of the plurality of heaters, wherein the plurality of heaters may include a first heater and a second heater, wherein the first deformation portion may function as a thermal switch, the first deformation portion being deformed in response to a temperature change caused by the first heater so that power is supplied to the second heater.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2A illustrates an aerosol generating device according to an embodiment;

FIG. 2B illustrates an aerosol generating device according to an embodiment;

FIG. 3 illustrates an aerosol generating device according to an embodiment;

FIG. 4A and FIG. 4B are views illustrating a heater of an aerosol generating device according to embodiments;

FIG. 5A is a perspective view showing a first state of an aerosol generating device to which an example of a heater is applied;

FIG. 5B is a perspective view showing a second state of the aerosol generating device of FIG. 5A;

FIG. 6A is a perspective view showing a first state of an aerosol generating device to which another example of a heater is applied;

FIG. 6B is a perspective view showing a second state of the aerosol generating device of FIG. 6A;

FIG. 7A is a perspective view showing a first state of an aerosol generating device to which another example of a heater is applied;

FIG. 7B is a perspective view showing a second state of the aerosol generating device of FIG. 7A;

FIG. 8A is a cross-sectional view showing a first state of an aerosol generating device to which one fixed heater and one movable heater are applied;

FIG. 8B is a cross-sectional view showing a second state of the aerosol generating device of FIG. 8A;

FIG. 9A is a cross-sectional view showing a first state of an aerosol generating device to which two fixed heaters and one movable heater are applied;

FIG. 9B is a cross-sectional view showing a second state of the aerosol generating device of FIG. 9A;

FIG. 10A is a cross-sectional view showing a first state of an aerosol generating device to which a different type of deformation portion is applied compared to FIG. 8A;

FIG. 10B is a cross-sectional view showing a second state of the aerosol generating device of FIG. 10A;

FIG. 11A is a cross-sectional view showing a first state of an aerosol generating device to which a longitudinally movable heater is applied;

FIG. 11B is a cross-sectional view showing a second state of the aerosol generating device of FIG. 11A;

FIG. 12A is a cross-sectional view showing a first state of an aerosol generating device to which a circumferentially movable heater is applied;

FIG. 12B is a cross-sectional view showing a second state of the aerosol generating device of FIG. 12A;

FIG. 13A-FIG. 13E are views schematically illustrating an aerosol generating device to which a plurality of heaters that are sequentially activated are applied; and

FIG. 14A and FIG. 14B are perspective views each illustrating a plurality of heaters that are sequentially activated.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry. ” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

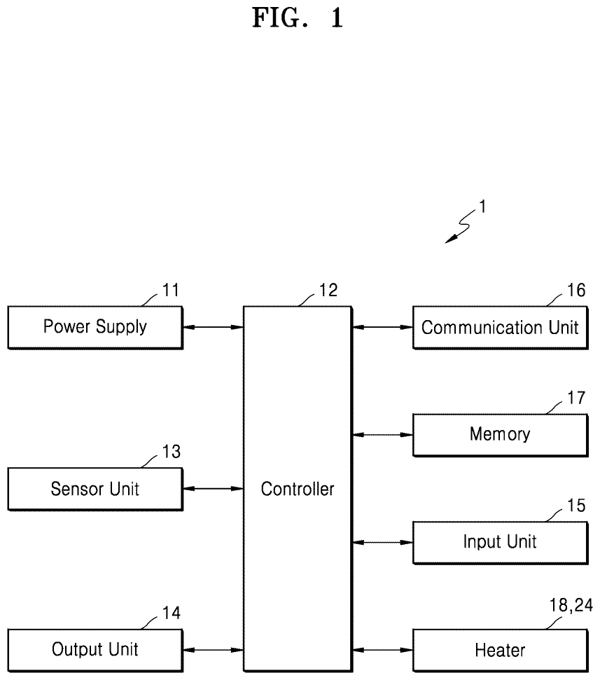

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space of the aerosol-generating article, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

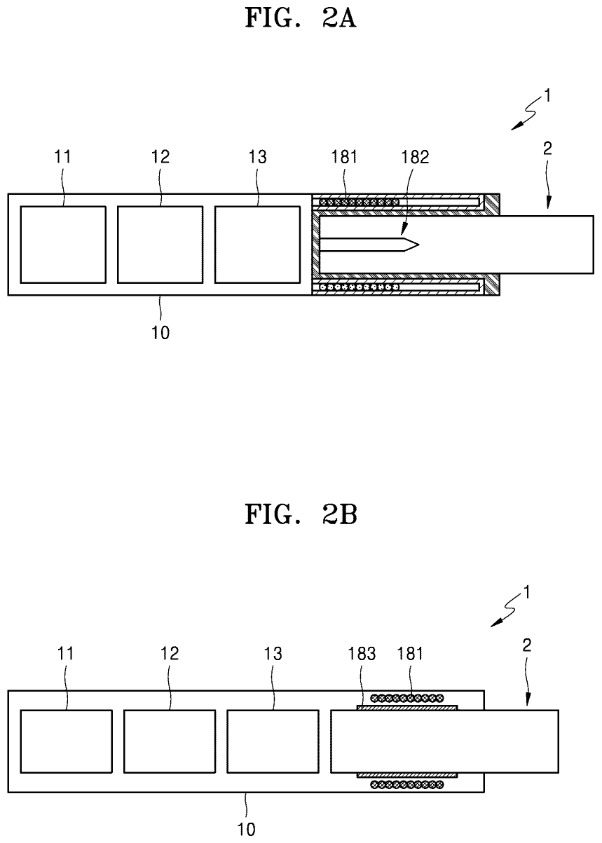

FIG. 2a shows an aerosol-generating device 1 according to an embodiment. FIG. 2b shows an aerosol-generating device 1 according to an embodiment.

According to one embodiment, the aerosol-generating device 1 may include a housing 10, a power supply 11, a controller 12, a sensor unit 13, and/or a heater 182 and 183 (e.g., the heater 18 in FIG. 1). However, it will be understood by those skilled in the art related to the present embodiment that the components included in the aerosol-generating device 1 are not limited to those shown in FIG. 2a or FIG. 2b and that some of the components may be omitted or new components may be further included. The aerosol-generating device 1 shown in FIG. 2a may be referred to as an “internal heating-type” aerosol-generating device that heats the inner side of an aerosol-generating article 2. The aerosol-generating device 1 shown in FIG. 2b may be referred to as an “external heating-type” aerosol-generating device that heats the outer side of the aerosol-generating article 2. In the drawings below, a description of configurations identical to those shown in FIG. 1 will be omitted.

According to one embodiment, the housing 10 may provide a space that is open upwardly to allow the aerosol-generating article 2 to be inserted thereinto. In the present disclosure, the space that is open upwardly may be referred to as an insertion space. The insertion space may be formed so as to be depressed in the housing 10 to a predetermined depth so that at least a portion of the aerosol-generating article 2 may be inserted thereinto. The depth of the insertion space may be equal to or greater than the length of a region of the aerosol-generating article 2 in which an aerosol-generating substance and/or a medium is contained. The lower end of the aerosol-generating article 2 may be inserted into the housing 10, and the upper end of the aerosol-generating article 2 may protrude outside the housing 10. A user may inhale an aerosol while holding the externally exposed upper end of the aerosol-generating article 2 in the mouth.

According to one embodiment, the heater 182 and 183 may heat the aerosol-generating article 2.

Referring to FIG. 2a, the heater 182 may be an internal heating-type heater.

According to one embodiment, the internal heating-type heater may be elongated upwardly in the space into which the aerosol-generating article 2 is inserted (i.e., the insertion space). For example, as shown in the drawings, the internal heating-type heater may include a rod-shaped or needle-shaped heating element. Alternatively, the internal heating-type heater may include various other heating elements, such as a tubular heating element or a plate-shaped heating element. The internal heating-type heater may be inserted through the lower portion of the aerosol-generating article 2.

According to one embodiment, the internal heating-type heater may include an electro-resistive heater and/or an induction heater.

For example, the electro-resistive heater may include an electro-resistive material, which is provided on the inner side (e.g., in the cavity or on the inner surface) or outer side (e.g., on the outer surface) thereof, and may generate heat as current flows through the electro-resistive material. In this case, the electro-resistive heater may be electrically connected to the power supply 11, and may directly generate heat using current received from the power supply 11. Meanwhile, an induction coil 181 may be omitted.

For example, in the case of an induction heater, the aerosol-generating device 1 may include an induction coil 181 surrounding at least a portion of the internal heating-type heater (e.g., disposed outside the heater so as to correspond to the length of at least a portion of the heater). In this case, a magnetic flux concentrator may be further provided outside the induction coil 181 in order to increase efficiency of induction heating. The induction heater may include a susceptor, and may generate heat based on a magnetic field generated by the induction coil 181. According to one embodiment, the induction heater (e.g., the susceptor) (or a heater module including the same) may be disposed to be removable from the housing 10.

According to one embodiment, the heater 182 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 182 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 182 in the longitudinal direction, respectively. In addition, three or more heaters and/or three or more induction coils may be included.

According to one embodiment, the susceptor may be disposed on (or included in) the inner side (e.g., the medium portion) of the aerosol-generating article 2. The susceptor included inside the aerosol-generating article 2 may be implemented to be heated based on a magnetic field generated by the induction coil 181.

Referring to FIG. 2b, the heater 183 may be an external heating-type heater.

According to one embodiment, the external heating-type heater may be elongated upwardly around the space into which the aerosol-generating article 2 is inserted (i.e., the insertion space). For example, the external heating-type heater may be disposed so as to surround at least a portion of the insertion space. In an example, the external heating-type heater may include a tube shape (e.g., a cylindrical shape) with a cavity formed therein. The external heating-type heater may alternatively include a shape including a cavity formed therein and surrounding the cavity. In this case, the external heating-type heater may be supported by a polyimide film. The heater supported by this film may be referred to as a film heater. The external heating-type heater may be disposed so as to surround at least a portion of the insertion space. The external heating-type heater may heat the outer side of the aerosol-generating article 2 inserted into the cavity.

According to one embodiment, the external heating-type heater may include an electro-resistive heater and/or an induction heater, and a description of configurations identical to those shown in FIG. 2a will be omitted. Meanwhile, in the case of an induction heater, the aerosol-generating device 1 may include an external heating-type heater implemented as a tubular susceptor and may include an induction coil 181 surrounding at least a portion of the external heating-type heater (e.g., disposed outside the heater so as to correspond to the length of at least a portion of the heater). In addition, the induction coil 181 may include a fan coil. Meanwhile, if the external heating-type heater is an electro-resistive heater, heat may be generated through current flow through the tubular electro-resistive heater (e.g., the film heater), and thus a separate induction coil 181 may be omitted. Meanwhile, a thermally insulating material may be disposed outside the external heating-type heater. Accordingly, the amount of heat emitted from the heater 183 in the radially outward direction and released outside the housing 10 may be reduced.

According to one embodiment, the heater 183 may be a multi-heater, and the first heater and the second heater may be disposed side by side in the longitudinal direction so as to surround at least a portion of the insertion space. The first heater and the second heater may operate as an electro-resistive heater and/or an induction heater, and may be heated sequentially or simultaneously. Meanwhile, if the heater 183 is an induction heater, the aerosol-generating device 1 may include a first induction coil and a second induction coil. The first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively.

Unlike the configuration shown in FIG. 2a or FIG. 2b, both the heater 182 in FIG. 2a and the heater 183 in FIG. 2b may be included in the aerosol-generating device 1. In this case, the heater 182 may heat the inner side of the aerosol-generating article 2, and the heater 183 may heat the outer side of the aerosol-generating article 2.

According to one embodiment, the aerosol-generating device 1 may be provided with an airflow channel through which air flows. For example, the housing 10 may include a structure (e.g., a hole) through which outside air may be introduced into the housing 10. The air introduced into the housing 10 may be introduced into the aerosol-generating article 2 through the lower end (i.e., upstream side) of the aerosol-generating article 2. An aerosol generated based on heating of the aerosol-generating article 2 may be inhaled into the user's oral cavity together with the introduced air through the upper end (i.e., downstream side) of the aerosol-generating article 2.

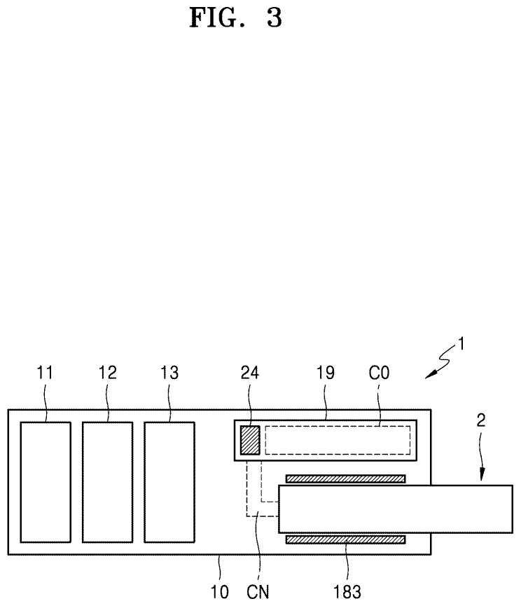

FIG. 3 shows an aerosol-generating device 1 according to an embodiment.

According to one embodiment, the aerosol-generating device 1 may include a housing 10, a power supply 11, a controller 12, a sensor unit 13, and/or a heater 183 and 24 (e.g., the heater 18 and 24 in FIG. 1). However, it will be understood by those skilled in the art related to the present embodiment that the components included in the aerosol-generating device 1 are not limited to those shown in FIG. 3 and that some of the components may be omitted or new components may be further included. In the drawings below, a description of configurations identical to those shown in FIG. 1 will be omitted.

According to one embodiment, the housing 10 may provide a space that is open upwardly to allow the aerosol-generating article 2 to be inserted thereinto (hereinafter referred to as an insertion space). The insertion space may be formed so as to be depressed in the housing 10 to a predetermined depth so that at least a portion of the aerosol-generating article 2 may be inserted thereinto. The lower end of the aerosol-generating article 2 may be inserted into the housing 10, and the upper end of the aerosol-generating article 2 may protrude outside the housing 10.

Unlike the configuration shown in the drawings, the cartridge 19 may provide an insertion space for receiving the aerosol-generating article 2. In this case, the insertion space may be formed so as to be depressed in the cartridge 19 to a predetermined depth so that at least a portion of the aerosol-generating article 2 may be inserted thereinto. The lower end of the aerosol-generating article 2 may be inserted into the cartridge 19, and the upper end of the aerosol-generating article 2 may protrude outside the cartridge 19. In this case, the aerosol-generating device 1 may not include the heater 183.

According to one embodiment, the depth of the insertion space may be equal to or greater than the length of a region of the aerosol-generating article 2 in which an aerosol-generating substance and/or a medium is contained. A user may inhale air while holding the externally exposed upper end of the aerosol-generating article 2 in the mouth.

According to one embodiment, the heater 183 may heat the aerosol-generating article 2. The heater 183 may be elongated upwardly around the space into which the aerosol-generating article 2 is inserted (i.e., the insertion space). In an example, the heater 183 may have a tube shape (e.g., a cylindrical shape) with a cavity formed therein. The heater 183 may include a shape including a cavity formed therein and surrounding the cavity. In this case, the heater 183 may be supported by a polyimide film. The heater supported by this film may be referred to as a film heater. The heater 183 may be disposed so as to surround at least a portion of the insertion space. The heater 183 may heat the outer side of the aerosol-generating article 2 inserted into the cavity. In the present disclosure, the heater 183 may be referred to as an external heating-type heater, which heats the outer side of the aerosol-generating article 2. Meanwhile, a thermally insulating material may be disposed outside the heater 183. Accordingly, the amount of heat emitted from the heater 183 in the radially outward direction and released outside the housing 10 may be reduced.

According to one embodiment, the heater 183 may include an electro-resistive heater and/or an induction heater.

For example, the electro-resistive heater may include an electro-resistive material, and may generate heat as current flows through the electro-resistive material. In this case, the electro-resistive heater may be electrically connected to the power supply 11, and may directly generate heat using current received from the power supply 11.

For example, in the case of an induction heater, the aerosol-generating device 1 may further include an induction coil (not shown) surrounding at least a portion of the heater 183 (e.g., disposed outside the heater 183 so as to correspond to the length of at least a portion of the heater 183). In this case, a magnetic flux concentrator may be further provided outside the induction coil (not shown) in order to increase efficiency of induction heating. The induction heater may include a susceptor, and may generate heat based on a magnetic field generated by the induction coil (not shown).

According to one embodiment, the heater 183 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 183 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively. In addition, three or more heaters and/or three or more induction coils may be included.

Unlike the configuration shown in the drawings, the aerosol-generating device 1 may not include the heater 183. The aerosol-generating article 2 may be directly or indirectly heated by the cartridge heater 24 or may not be substantially heated. Indirect heating may mean that the aerosol-generating article 2 is heated by receiving heat contained in the aerosol during the process in which the aerosol generated by the cartridge heater 24 passes through the aerosol-generating article 2. In this case, the aerosol-generating device 1 may be referred to as a non-heating-type (or indirect heating-type) aerosol-generating device. An additive such as an alkaline substance may be contained in the aerosol-generating rod of the aerosol-generating article 2. Based on the alkaline substance, nicotine contained in the aerosol-generating rod may have an alkaline pH (e.g., pH 7.0 or higher). This alkaline nicotine may flow to the user's oral cavity together with the aerosol introduced into the aerosol-generating article 2 from the cartridge 19 to be described later.

Unlike the configuration shown in the drawings, the heater 183 may include an internal heating-type heater. For example, the internal heating-type heater may include various heating elements, such as a rod-shaped heating element, a tubular heating element, a plate-shaped heating element, or a needle-shaped heating element. The internal heating-type heater may be inserted through the lower portion of the aerosol-generating article 2, and may be set to heat the inner side of the aerosol-generating article 2.

According to one embodiment, the cartridge 19 may be removably coupled to the housing 10. For example, a space may be formed in one side of the housing 10, and at least a portion of the cartridge 19 may be inserted into the space formed in one side of the housing 10 so that the cartridge 19 is mounted to the housing 10. Alternatively, the cartridge 19 may be integrally formed with the housing 10.

According to one embodiment, the aerosol-generating device 1 and/or the cartridge 19 may be provided with an airflow channel through which air flows. For example, the housing 10 may include a structure allowing outside air to be introduced into the housing 10 in the state in which the cartridge 19 is inserted thereinto. The introduced air may pass through the cartridge 19, may be introduced into the insertion space through the airflow channel CN, and then may flow to the user's oral cavity. The airflow channel CN may include various structures for reducing residual droplets or making the flow of air smooth.

Although it is illustrated in FIG. 3 that the cartridge 19 is located beside the aerosol-generating article 2 and the airflow channel CN is formed from the side surface of the aerosol-generating article 2 to the lower end (i.e., upstream side) of the aerosol-generating article 2, the positions of the cartridge 19 and the airflow channel CN are not limited thereto. For example, the cartridge 19 may be located adjacent to the lower end (i.e., upstream side) of the aerosol-generating article 2. In this case, the airflow channel CN may be formed in a substantially straight shape to connect the cartridge 19 to the lower end (i.e., upstream side) of the aerosol-generating article 2.

According to one embodiment, the cartridge 19 may include a storage part C0 that contains an aerosol-generating substance, a cartridge heater 24, and/or a liquid delivery part that is impregnated with (contains) the aerosol-generating substance. The liquid delivery part 25 may be impregnated with the aerosol-generating substance supplied from the chamber C0. For example, the liquid delivery part may include a wick formed of, e.g., cotton fiber, ceramic fiber, glass fiber, or porous ceramic.

According to one embodiment, the cartridge heater 24 may heat the aerosol-generating substance contained in the cartridge 19. For example, the cartridge heater 24 may include an electro-resistive heater and/or an induction heater.

In an example, the electro-resistive heater may include an electro-resistive material, and may generate heat as current flows through the electro-resistive material. In another example, in the case of an induction heater, the aerosol-generating device 1 may further include an induction coil (not shown) provided around the induction heater. The induction heater may include a susceptor, and may generate heat based on a magnetic field generated by the induction coil (not shown). The cartridge heater 24 may be formed in a coil shape surrounding (or wound around) the liquid delivery part and/or in a shape (e.g., a patterned shape) contacting one side of the liquid delivery part.

Unlike the configuration shown in the drawings, the cartridge heater 24 may be included in the aerosol-generating device 1. For example, the cartridge heater 24 may be included inside the housing 10. In this case, the cartridge 19 and the cartridge heater 24 may be separated by removal of the cartridge 19.

According to one embodiment, an aerosol may be generated based on generation of heat by the cartridge heater 24. For example, as the aerosol-generating substance impregnated in the liquid delivery part is heated by the cartridge heater 24, vapor may be generated from the aerosol-generating substance, and an aerosol may be generated as the generated vapor is mixed with the outside air introduced into the cartridge 19. The aerosol generated by the cartridge heater 24 may be introduced into the aerosol-generating article 2 through the airflow channel CN. While the aerosol passes through the aerosol-generating article 2, tobacco or a flavoring substance may be added to the aerosol, and the aerosol containing the tobacco or the flavoring substance may be inhaled into the user's oral cavity through one end of the aerosol-generating article 2.

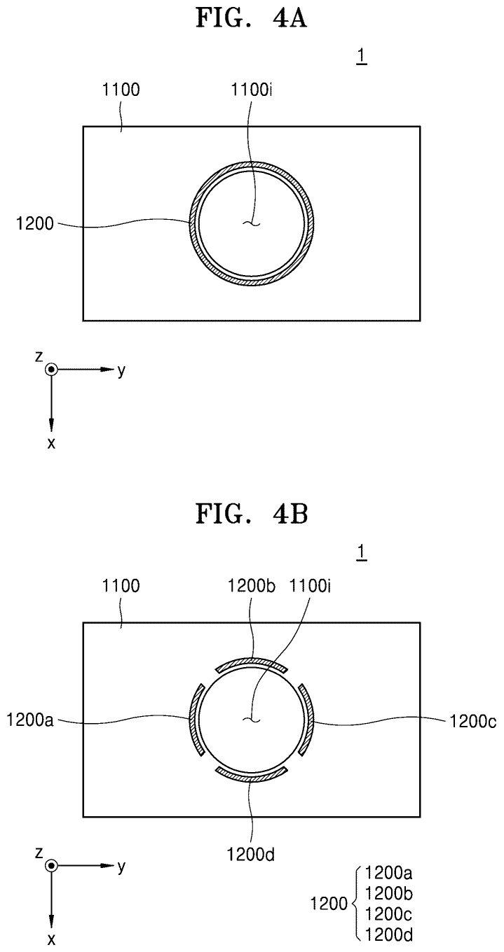

FIGS. 4A and 4B are views illustrating a heater of an aerosol generating device according to embodiments.

Referring to FIGS. 4A and 4B, an aerosol generating device 1 according to embodiments may include a housing 1100 and a heater 1200.

The housing 1100 forms the overall appearance of the aerosol generating device 1 and may include an internal space in which components of the aerosol generating device 1 may be arranged. A heater 1200, a power supply, a controller, etc. may be arranged in the internal space of the housing 1100, but in FIGS. 4A and 4B, other components other than the heater 1200 are omitted for convenience of description.

The housing 1100 may have a square column shape having a rectangular cross-section. However, the shape of the housing 1100 is not limited to that shown in FIG. 4A, and the housing 1100 may be formed as a cylindrical shape or a polygonal column shape as a whole.

The housing 1100 may have an opening through which an aerosol generating article may be inserted into the interior of the housing 1100. At least a portion of the aerosol generating article may be inserted or accommodated in the interior of the housing 1100 through the opening.

The housing 1100 may include an insertion space 1100i for accommodating an aerosol generating article (e.g., the aerosol generating article 2 of FIG. 3) therein. The insertion space 1100i may be formed at an upper portion of the housing 1100. The insertion space 1100i may be opened upward and connected to the opening.

The insertion space 1100i may have a cylindrical shape that extends vertically. Through the opening on the upper side of the insertion space 1100i, at least a portion of the aerosol generating article may be accommodated inside the housing 1100. In this case, the depth of the insertion space 1100i of the aerosol generating article may correspond to the length of a region containing the aerosol generating material or a medium in the aerosol generating article.

The heater 1200 is configured to heat the aerosol generating article 2 accommodated in the insertion space 1100i. The heater 1200 may generate aerosol from the aerosol generating article 2. The heater 1200 may extend vertically along the insertion space 1100i.

As illustrated in FIG. 4A, the heater 1200 may be a cylindrical electrical resistance heater surrounding at least a portion of the insertion space 1100i. As illustrated in FIG. 4B, the heater 1200 may include a plurality of electrical resistance heaters 1200a, 1200b, 1200c, and 1200d each surrounding a portion of the insertion space 1100i and having an arc-shaped cross-section. The plurality of electrical resistance heaters 1200a, 1200b, 1200c, and 1200d may be arranged spaced apart from each other in a circumferential direction of the heater 1200.

However, the embodiment is not limited to the shape and arrangement of the heater 1200. As another example, the heater 1200 may include a cylindrical susceptor surrounding at least a portion of the insertion space 1100i and an induction coil surrounding the susceptor. As another example, the heater 1200 may be inserted into the interior of the aerosol generating article 2 accommodated in the insertion space 1100i and heat the interior of the aerosol generating article 2.

At least one area of the aerosol generating article 2 accommodated in the insertion space 1100i may be heated by the heater 1200, and vaporized particles generated by the heating of the aerosol generating article 2 may be mixed with air introduced into the internal space of the housing 1100 through an air inlet (e.g., an opening) formed in one area of the housing 1100 to generate an aerosol.

The heater 1200 may be a cartridge heater (e.g., the cartridge heater 24 of FIG. 3). In this case, the aerosol generating article 2 may be the cartridge 19 of FIG. 3, rather than a cigarette or a stick.

Hereinafter, a case in which the heating area of an aerosol generating article increases over time while heating the aerosol generating article will be described.

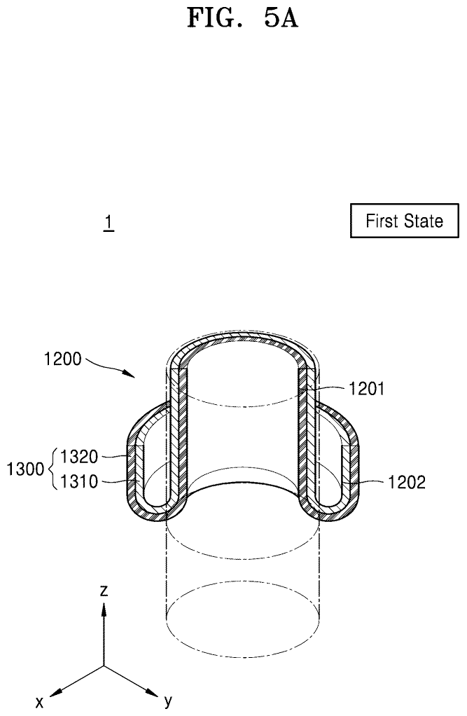

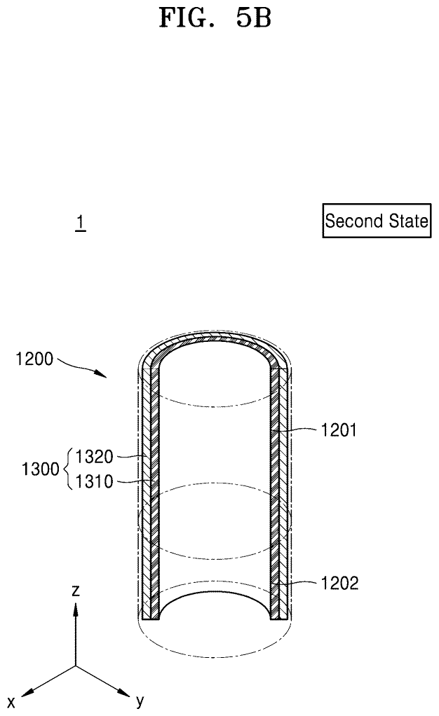

FIG. 5A is a perspective view showing a first state of an aerosol generating device to which an example of a heater is applied. FIG. 5B is a perspective view showing a second state of the aerosol generating device of FIG. 5A.

Referring to FIGS. 5A and 5B, an aerosol generating device 1 according to an embodiment may include a heater 1200. In this case, the shape of the heater 1200 may vary depending on the temperature.

Regarding the changing shape of the heater, FIG. 5A of the first state shows a shape in which a lower portion of the heater 1200 is rolled to the outside of an upper portion of the heater 1200. FIG. 5B of the second state shows a shape in which the lower portion of the heater 1200 that was rolled upward is spread out, so that the heater 1200 has an overall cylindrical shape.

Specifically, the heater 1200 may include a fixed portion 1201 and a deformable portion 1202. In FIG. 5A, the fixed portion 1201 is a portion located inside a cylindrical dash-dot line, and the deformable portion 1202 is a portion located outside the cylindrical dash-dot line. In FIG. 5B, the fixed portion 1201 is a portion located above a circular dash-dot line that cuts a cylindrical dash-dot line in a transverse direction, and the deformable portion 1202 is a portion located below the circular dash-dot line.

The fixed portion 1201 may be located inside the dash-dot line regardless of the temperature of the heater 1200. The deformable portion 1202 may change the shape thereof depending on the temperature of the heater 1200 and thus may move from the outside to the inside of the dash-dot line.

In order for the shape of the heater 1200 to change depending on the temperature, the heater 1200 may include a bimetal 1300. In this case, with respect to the fixed portion 1201 of the heater 1200, a metal 1310 having a large thermal expansion coefficient may be placed relatively outside, and a metal 1320 having a small thermal expansion coefficient may be placed relatively inside. In this case, the metal 1310 having a large thermal expansion coefficient is referred to as a first metal 1310, and the metal 1320 having a small thermal expansion coefficient is referred to as a second metal 1320. The first metal 1310 and the second metal 1320 may be used with the same meaning throughout the specification.

The first state may mean a state in which power is not supplied to the heater 1200. That is, the heater 1200 in the first state does not generate heat and does not heat an aerosol generating article. The second state may mean a state in which power is supplied to the heater 1200 and heat is generated. In this case, the aerosol generating article may be heated. The first state and the second state may be used with the same meaning throughout the specification.

During the change from the first state to the second state, power may be supplied to the heater 1200, and the temperature of the heater 1200 may gradually increase. As the temperature of the heater 1200 increases, the first metal 1310 placed relatively outside the fixed portion 1201 of the heater 1200 deforms more than the second metal 1320 placed inside, and thus, the lower portion of the heater 1200, which was rolled upward, may be spread out. Accordingly, a region located inside the dash-dot line in the heater 1200 may gradually increase.

A region of the heater 1200 located inside the dash-dot line may heat the aerosol generating article by coming into contact with the outer surface of the aerosol generating article. As the temperature of the heater 1200 increases, the region of the heater 1200 located inside the dash-dot line gradually increases, and thus, the heated area of the aerosol generating article may increase over time.

The fixed portion 1201 of the heater 1200 may heat the aerosol generating article from the time when power is supplied to the heater 1200 and heat is generated. The deformable portion 1202 of the heater 1200 may deform as the temperature increases and may heat the aerosol generating article from the time when the deformable portion 1202 comes into contact with the aerosol generating article. That is, an upper portion of the medium of the aerosol generating article may be heated first, and upper and lower portions of the medium can be heated together over time.

Because the lower portion of the medium is heated later than the upper portion of the medium, aerosol may be generated from the upper portion of the medium during an initial heating of the heater 1200, and aerosol may be generated mainly from the lower portion of the medium during a latter part of heating. Accordingly, by preventing the entire area of the medium from being heated in a short period of time, the user may inhale a uniform amount of aerosol during the time of using the aerosol generating device 1.

As the use of the aerosol generating device 1 is finished and the temperature of the heater 1200 is lowered, the heater 1200 may change from the shape in the second state to the shape in the first state. That is, the lower portion of the heater 1200 may be rolled up toward the upper portion of the heater 1200 again. When the user uses the aerosol generating device 1 again, the heater 1200 may change from the shape in the first state to the shape in the second state again.

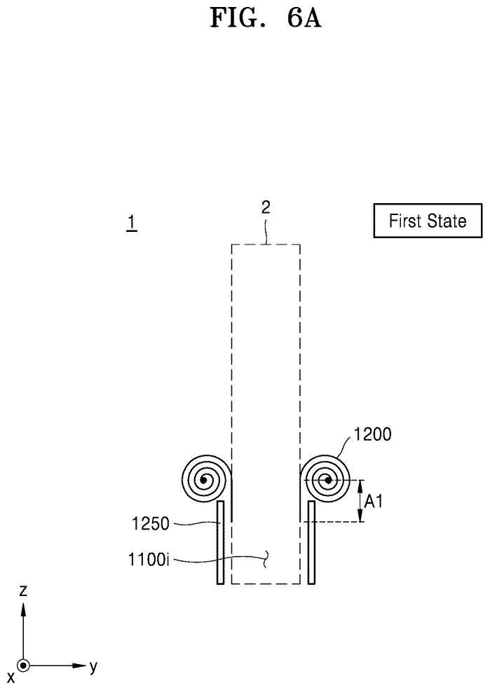

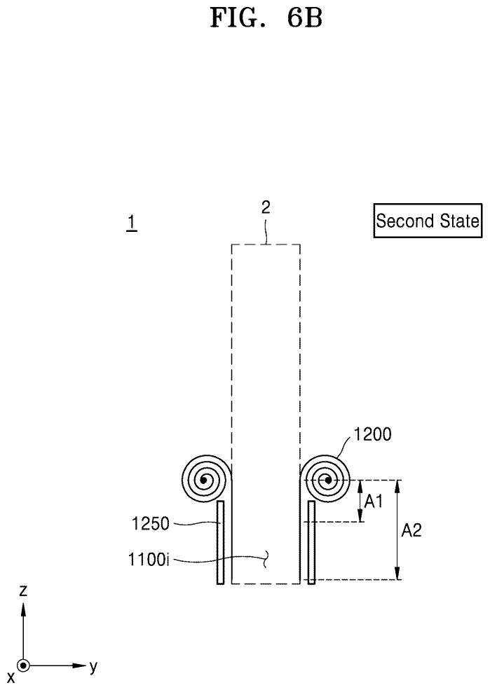

FIG. 6A is a perspective view showing a first state of an aerosol generating device to which an example of a heater is applied. FIG. 6B is a perspective view showing a second state of the aerosol generating device of FIG. 6A.

Referring to FIGS. 6A and 6B, an aerosol generating device 1 according to an embodiment may include a heater 1200. In this case, the heater 1200 may have a plate-shaped coil shape. The heater 1200 having a plate-shaped coil shape may have a certain width in a circumferential direction of an insertion space (e.g., the insertion space 1100i of FIG. 4A). Because the heater 1200 has a certain width, the heater 1200 may come into contact with the outer surface of an aerosol generating article 2 by the certain width in the circumferential direction of the insertion space 1100i.

As shown in FIGS. 6A and 6B, two heaters 1200 having plate-shaped coil shapes are arranged, but the embodiment is not limited thereto. A plurality of heaters 1200 having plate-shaped coil shapes may be arranged along the circumference of the insertion space 1100i.

One end of the heater 1200 may be located at the center of the plate-shaped coil. One end of the heater 1200 may be fixed to a housing (e.g., the housing 1100 of FIG. 4A) or a component arranged inside the housing 1100. The other end of the heater 1200 may be located at the edge of the plate-shaped coil. According to an embodiment, the other end of the heater 1200 may be located at a portion extending tangentially from the edge of the plate-shaped coil.

In the first state, the other end of the heater 1200 may come into contact with the aerosol generating article 2 accommodated in the insertion space 1100i. However, a coiled portion of the heater 1200, including one end of the heater 1200, may not be in contact with the aerosol generating article 2.

As power is supplied to the heater 1200, the heater 1200 may heat the aerosol generating article 2 through the other end of the heater 1200. Specifically, an area A1 of the aerosol generating article 2 that is in contact with the other end of the heater 1200 may be heated. Because the coiled portion of the heater 1200 does not contact the aerosol generating article 2, the aerosol generating article 2 may not be heated.

The shape of the heater 1200 may vary depending on the temperature. Specifically, the other end of the heater 1200 may extend or contract in a longitudinal direction (e.g., in the z-axis direction) of the insertion space 1100i in response to the temperature of the heater 1200. During the change from the first state to the second state, as the temperature of the heater 1200 increases, the other end of the heater 1200 may extend to be elongated in the longitudinal direction of the insertion space 1100i.

As the other end of the heater 1200 extends in the longitudinal direction of the insertion space 1100i, the area in which the heater 1200 and the outer surface of the aerosol generating article 2 come into contact with each other may increase. Accordingly, the area in which the aerosol generating article 2 is heated by the heater 1200 may increase.

In the second state, not only the upper portion but also the lower portion of the medium of the aerosol generating article 2 may come into contact with the other end of the heater 1200. That is, an area A2 of the aerosol generating article 2 that comes into contact with the other end of the heater 1200 may increase compared to a contact area (i.e., the area A1) in the first state. Due to the shape change of the heater 1200, the upper portion of the medium of the aerosol generating article 2 may be heated first, and the upper and lower portions of the medium may be heated together over time.

Because the lower portion of the medium is heated later than the upper portion of the medium, aerosol may be generated from the upper portion of the medium during an initial heating of the heater 1200, and aerosol may be generated mainly from the lower portion of the medium during a latter part of heating. Accordingly, by preventing the entire area of the medium from being heated in a short period of time, the user may inhale a uniform amount of aerosol during the time of using the aerosol generating device 1.

As the use of the aerosol generating device 1 is finished and the temperature of the heater 1200 is lowered, the heater 1200 may change from the shape in the second state to the shape in the first state. That is, the other end of the heater 1200 may contract in the longitudinal direction of the insertion space 1100i. When the user uses the aerosol generating device 1 again, the heater 1200 may change from the shape in the first state to the shape in the second state again.

The other end of the extending heater 1200 may not straightly extend but may bend along a coil shape. Accordingly, the other end of the extended heater 1200 may not come into contact with the aerosol generating article 2.

To solve this problem, the aerosol generating device 1 according to an embodiment may further include a heater guide 1250. The heater guide 1250 may support at least a portion of the heater 1200 so that the other end of the heater 1200 may extend only in the longitudinal direction of the insertion space 1100i. The other end of the heater 1200 may extend only in one direction by the heater guide 1250 and may maintain contact with the outer surface of the aerosol generating article 2.

In addition, the heater guide 1250 may include an insulating material. The heater guide 1250 may confine the heat generated from the other end of the heater 1200 to the inside of the heater guide 1250. Accordingly, the heating efficiency of the aerosol generating article 2 may be improved.

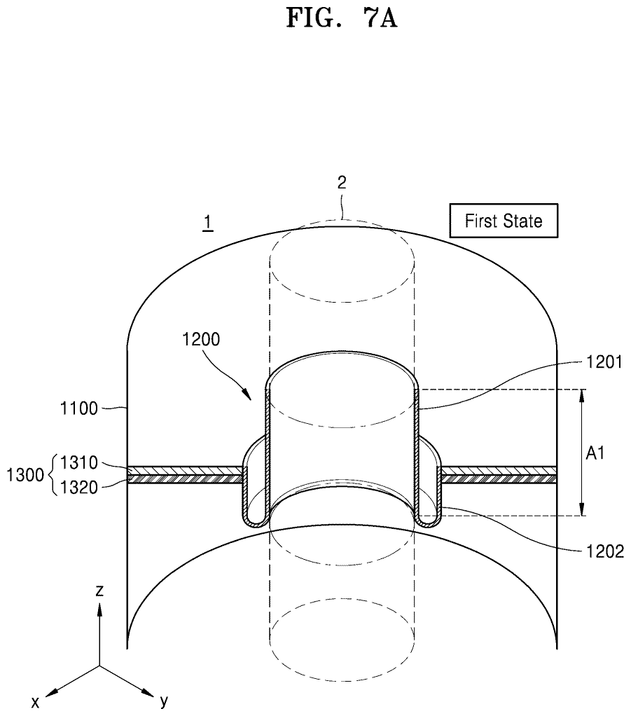

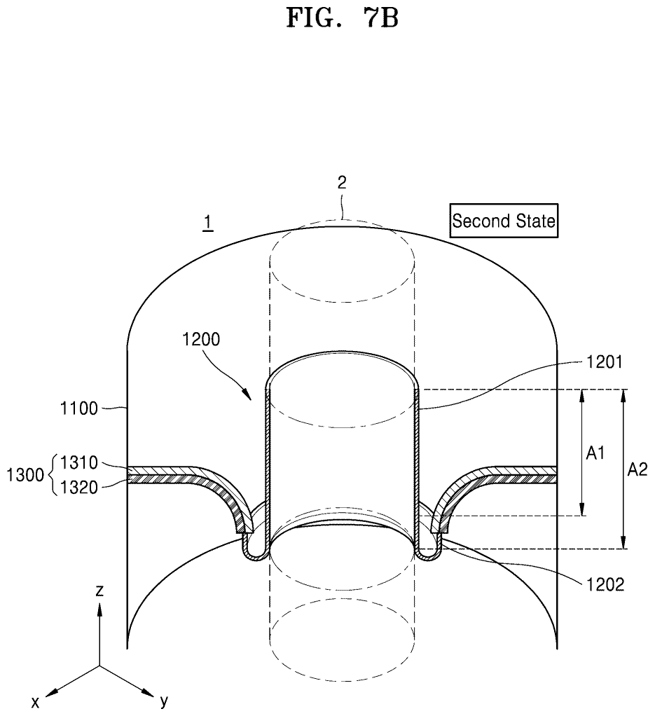

FIG. 7A is a perspective view showing a first state of an aerosol generating device to which another example of a heater is applied. FIG. 7B is a perspective view showing a second state of the aerosol generating device of FIG. 7A.

Referring to FIGS. 7A and 7B, an aerosol generating device 1 according to an embodiment may include a housing 1100, a heater 1200, and a deformation portion 1300. In this case, the shape of the heater 1200 may change depending on the temperature.

As the temperature of the heater 1200 increases, a lower portion of the heater 1200 that has been rolled upward is spread out, which is the same as the descriptions given above with reference to FIGS. 5A and 5B.

However, unlike FIGS. 5A and 5B, the shape of the heater 1200 may change due to the deformation portion 1300 whose shape changes depending on the temperature of the heater 1200.

The deformation portion 1300 has a configuration that changes in response to a change in temperature. In the disclosure, the temperature of the deformation portion 1300 may change due to the heater 1200. For example, the deformation portion 1300 may be connected to the heater 1200. As the temperature of the heater 1200 changes, the temperature of the deformation portion 1300 connected to the heater 1200 may also change by absorbing the heat generated by the heater 1200.

That is, the embodiment illustrated in FIGS. 5A and 5B may be considered as a case where the deformation portion 1300 is the heater 1200 itself, and the embodiment illustrated in FIGS. 7A and 7B may be considered as a case where the deformation portion 1300 and the heater 1200 are separate components that are connected to each other.

The deformation portion 1300 may have a property of changing its shape depending on the temperature. For example, the deformation portion 1300 may be composed of at least one of a shape memory alloy, a shape memory polymer, a shape memory ceramic, or a bimetal, but is not necessarily limited thereto. Hereinafter, an embodiment in which the deformation part 1300 is a bimetal is mainly described.

As the temperature increases, a first metal 1310 may expand more than a second metal 1320. In this case, because both ends of the first metal 1310 and both ends of the second metal 1320 are connected to each other, the bimetal bends toward a metal with a smaller thermal expansion. As a result, the first metal 1310 may be positioned on the convex side of the bent bimetal, and the second metal 1320 may be positioned on the concave side of the bent bimetal.

The deformation portion 1300 in which the first metal 1310 and the second metal 1320 are coupled to each other may be straightened in the first state. During the change from the first state to the second state, the deformation portion 1300 whose temperature increases may bend. Because the thermal expansion coefficient of the first metal 1310 is greater than the thermal expansion coefficient of the second metal 1320, the deformation portion 1300 may bend in a direction in which the first metal 1310 faces the second metal 1320.

In this case, one end of the deformation portion 1300 may be fixed to the housing 1100 or a component placed inside the housing 1100, and the other end of the deformation portion 1300 may be connected to the heater 1200. In this case, the other end of the deformation portion 1300 may be connected to a portion 1202 that is rolled upward, not a spread portion 1201 of the heater 1200.

The heating area of the heater 1200 for the aerosol generating article 2 may vary depending on the deformation of the deformation portion 1300 due to a temperature change. Specifically, as the temperature of the deformation portion 1300 increases by the heater 1200, the heating area of the heater 1200 for the aerosol generating article 2 may increase.

For example, as the first metal 1310 of the deformation portion 1300 is bonded to the upper portion of the second metal 1320, the deformation portion 1300 may bend downward. While the position of one end of the fixed deformation portion 1300 does not change and the other end of the deformation portion 1300 bends downward, the rolled portion 1202 of the heater 1200 connected to the deformation portion 1300 may be spread downward.

In the first state, the spread portion 1201 of the heater 1200 may come into contact with the aerosol generating article 2, and the rolled portion 1202 of the heater 1200 does not come into contact with the aerosol generating article 2.

As power is supplied to the heater 1200, an area A1 of the aerosol generating article 2 that comes into contact with the spread portion 1201 of the heater 1200 may be heated. Because the rolled portion 1202 of the heater 1200 does not come into contact with the aerosol generating article 2, the aerosol generating article 2 may not be directly heated.

As the first state changes to the second state, the spread portion 1201 of the heater 1200 gradually increases by the deformation portion 1300. Accordingly, as the contact area between the heater 1200 and the aerosol generating article 2 increases, an area A2 of the aerosol generating article 2 that comes into contact with the spread portion 1201 of the heater 1200 may reach a maximum in the second state.

That is, as time passes after the start of heating, the area of the aerosol generating article 2 that is heated may increase. As described above, because the lower portion of the medium is heated later than the upper portion of the medium, the entire area of the medium may be prevented from being heated in a short period of time, and thus, the user may inhale a uniform amount of aerosol during the time of using the aerosol generating device.

As the use of the aerosol generating device 1 is finished and the temperatures of the heater 1200 and the deformation portion 1300 are lowered, the heater 1200 and the deformation portion 1300 may each change from the shape in the second state to the shape in the first state. That is, the deformation portion 1300 that was bent while being stretched may be straightened again by shrinking, and the lower portion of the heater 1200 may be rolled up toward the upper portion of the heater 1200 again.

When the user uses the aerosol generating device 1 again, the heater 1200 and the deformation portion 1300 may change from the shape in the first state to the shape in the second state again.

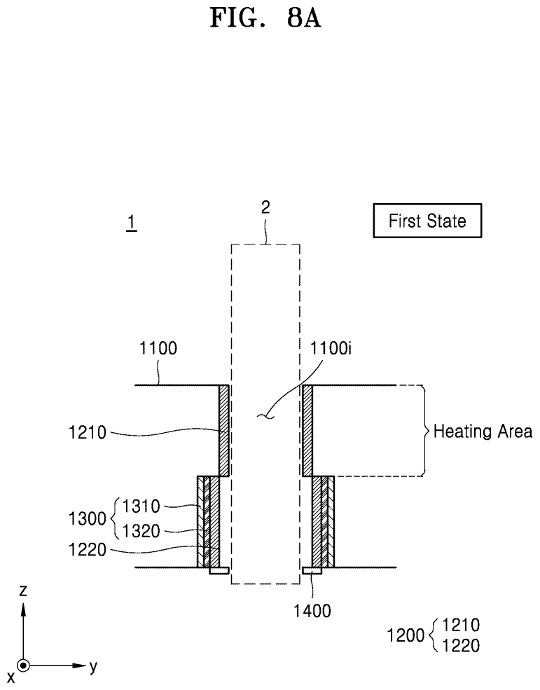

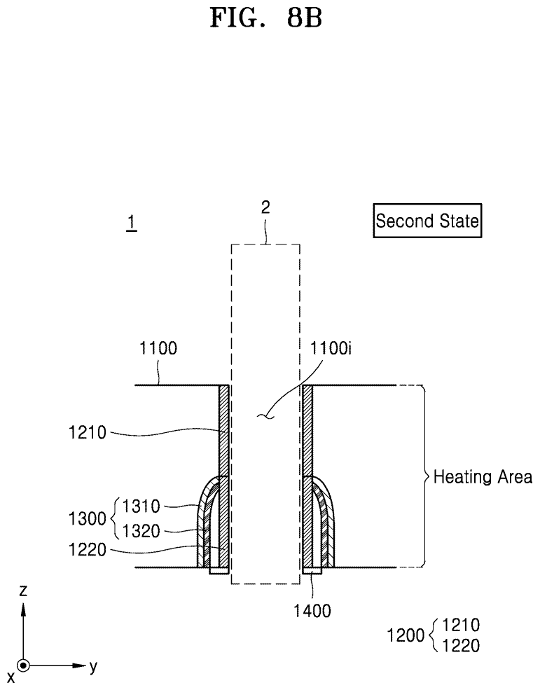

FIG. 8A is a cross-sectional view showing a first state of an aerosol generating device to which one fixed heater and one movable heater are applied. FIG. 8B is a cross-sectional view showing a second state of the aerosol generating device of FIG. 8A.

Referring to FIGS. 8A and 8B, an aerosol generating device 1 according to an embodiment may include a housing 1100, a heater 1200, and a deformation portion 1300.

The heater 1200 may include a first heater 1210 that is fixed and a second heater 1220 that is movable. As illustrated in FIGS. 8A and 8B, the second heater 1220 may be placed below the first heater 1210, but the embodiment is not limited to the relative positions of the two heaters 1200.

The second heater 1220 may be moved by the deformation portion 1300. Specifically, the second heater 1220 may be connected to the deformation portion 1300 and may move according to the deformation of the deformation portion 1300. One end of the deformation portion 1300 may be fixed to the housing 1100 or a component arranged inside the housing 1100, and the other end of the deformation portion 1300 may be connected to a portion of the second heater 1220. In this case, the deformation portion 1300 may be arranged parallel to the second heater 1220.

Depending on the deformation of the deformation portion 1300, the second heater 1220 may move between a first position spaced apart from an aerosol generating article 2 accommodated in an insertion space 1100i and a second position in contact with the aerosol generating article 2 accommodated in the insertion space 1100i. In this case, the first position may refer to the position of the second heater 1200 in the first state illustrated in FIG. 8A, and the second position may refer to the position of the heater 1200 in the second state illustrated in FIG. 8B.

In the first state, the first heater 1210 may be in contact with the aerosol generating article 2. The second heater 1220 may be placed apart from the insertion space 1100i or the aerosol generating article 2 accommodated in the insertion space 1100i.

As power is supplied to the heater 1200, a portion (e.g., an upper portion of a medium) of the aerosol generating article 2 in contact with the first heater 1210 may be heated. The area indicated as a ‘heating area’ in FIG. 8A may correspond to an area heated by the first heater 1210. In this case, because power is also supplied to the second heater 1220, the second heater 1220 may also emit heat. However, because the second heater 1220 does not come into contact with the aerosol generating article 2, the second heater 1220 may not directly heat the aerosol generating article 2.

While the temperature is increased by the second heater 1220 as the first state changes to the second state, the deformation portion 1300 may press the second heater 1220 so that the second heater 1220 moves toward the insertion space 1100i.

Specifically, the deformation portion 1300 may be arranged on the outside with respect to the second heater 1200. In this case, because a first metal 1310 having a large thermal expansion coefficient is placed further outward than a second metal 1320 having a small thermal expansion coefficient, the deformation portion 1300 in which the first metal 1310 and the second metal 1320 are coupled to each other may be stretched as the temperature increases and may bend toward the second heater 1220 at the same time.

While the position of one end of the fixed deformation portion 1300 does not change and the other end of the deformation portion 1300 bends toward the second heater 1220, the deformation portion 1300 may press the second heater 1220. Depending on the pressing of the deformation portion 1300, the second heater 1220 may move from a first position to a second position.

In the second state, not only the first heater 1210 but also the second heater 1220 may come into contact with the aerosol generating article 2. Accordingly, a portion (e.g., a lower portion of the medium) of the aerosol generating article 2 that comes into contact with the second heater 1220 may also be heated. The area indicated as a ‘heating area’ in FIG. 8B may correspond to an area heated by the first heater 1210 and the second heater 1220.

That is, when a certain time passes after the start of heating, the area of the aerosol generating article 2 that is heated may increase. In this case, the certain time may refer to the time taken for the second heater 1220 to move from the first position to the second position.

As described above, because the lower portion of the medium is heated later than the upper portion of the medium, the entire area of the medium may be prevented from being heated in a short period of time, and thus, the user may inhale a uniform amount of aerosol during the time of using the aerosol generating device.

As the use of the aerosol generating device 1 is finished and the temperatures of the heater 1200 and the deformation portion 1300 are lowered, the deformation portion 1300 may change from the shape in the second state to the shape in the first state. That is, the deformation portion 1300 that was stretched and bent at the same time may be straightened by shrinking again. Accordingly, the second heater 1200 may move from the second position to the first position again.

When the user uses the aerosol generating device 1 again, the deformation portion 1300 may change from the shape in the first state to the shape in the second state, and the second heater 1200 may move from the first position to the second position.

The aerosol generating device 1 may further include a rail 1400 for smooth movement of the second heater 1220. The rail 1400 may guide the movement of the second heater 1220. The rail 1400 may extend in a radial direction (e.g., in the y-axis direction) of the insertion space 1100i and may guide the movement of the second heater 1220.

The rail 1400 may be arranged inside the housing 1100, and the second heater 1220 may include a protrusion (not shown) to engage with the rail 1400. Accordingly, while the second heater 1220 moves, the protrusion of the second heater 1220 may be guided by the rail 1400 of the housing 1100, and thus, the second heater 1220 may stably move between the first position and the second position in the internal space of the housing 1100.

As described above, the protrusion is arranged on the second heater 1220 side, and the rail 1400 may include a groove structure that engages with the protrusion. However, the embodiment is not limited thereto. Conversely, a groove structure may be arranged on the second heater 1220 side, and the rail 1400 may be a protrusion inserted into a groove.

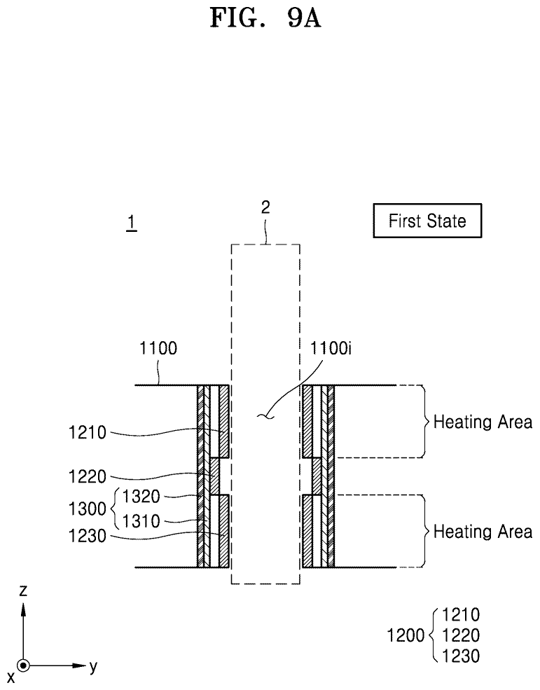

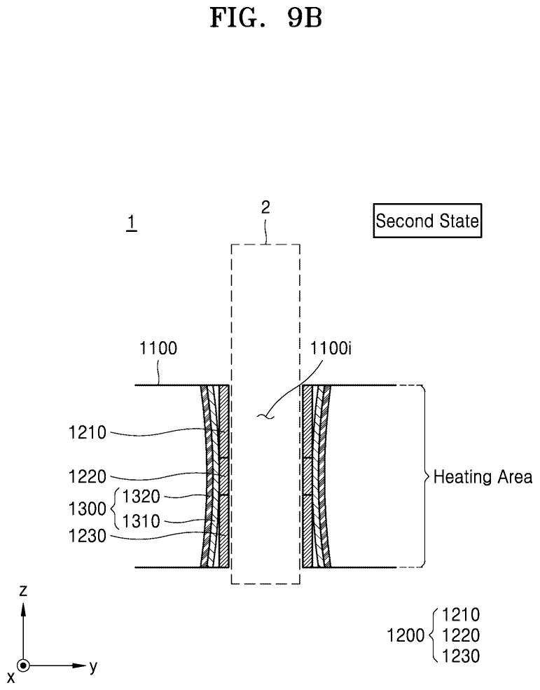

FIG. 9A is a cross-sectional view showing a first state of an aerosol generating device to which two fixed heaters and one movable heater are applied. FIG. 9B is a cross-sectional view showing a second state of the aerosol generating device of FIG. 9A.

Referring to FIGS. 9A and 9B, an aerosol generating device 1 according to an embodiment may include a housing 1100, a heater 1200, and a deformation portion 1300.

The heater 1200 may include a first heater 1210 that is fixed, a second heater 1220 that is movable, and a fixed third heater 1230 that is fixed. In this case, the second heater 1220 may be placed between the first heater 1210 and the third heater 1230.

The second heater 1220 may be moved by the deformation portion 1300. Specifically, the second heater 1220 may be connected to the deformation portion 1300 and may move according to the deformation of the deformation portion 1300. One end and the other end of the deformation portion 1300 may be fixed to the housing 1100 or a component arranged inside the housing 1100, and the second heater 1220 may be arranged at the center of the deformation portion 1300. Specifically, a portion of the second heater 1220 may be connected to the center of the deformation portion 1300. In this case, the deformation portion 1300 may be arranged to face the first heater 1210 and the third heater 1230.

Depending on the deformation of the deformation portion 1300, the second heater 1220 may move between a first position spaced apart from an aerosol generating article 2 accommodated in an insertion space 1100i and a second position in contact with the aerosol generating article 2 accommodated in the insertion space 1100i. In this case, the first position may refer to the position of the second heater 1200 in the first state illustrated in FIG. 9A, and the second position may refer to the position of the heater 1200 in the second state illustrated in FIG. 9B.

In the first state, the first heater 1210 and the third heater 1230 may come into contact with the aerosol generating article 2. The second heater 1220 may be arranged apart from the insertion space 1100i or the aerosol generating article 2 accommodated in the insertion space 1100i.

As power is supplied to the heater 1200, two portions (e.g., upper and lower portions of a medium) of the aerosol generating article 2 that are in contact with the first heater 1210 and the third heater 1230, respectively, may be heated. The area indicated as a ‘heating area’ in FIG. 9A may correspond to an area heated by the first heater 1210 and the third heater 1230. In this case, because power is also supplied to the second heater 1220, the second heater 1220 may also emit heat. However, because the second heater 1220 does not come into contact with the aerosol generating article 2, the second heater 1220 may not directly heat the aerosol generating article 2.

While the temperature is increased by the second heater 1220 as the first state changes to the second state, the deformation portion 1300 may press the second heater 1220 so that the second heater 1220 moves toward the insertion space 1100i.

Specifically, the deformation portion 1300 may be arranged on the outside with respect to the second heater 1200. In this case, because a first metal 1310 having a large thermal expansion coefficient is placed further inward than a second metal 1320 having a small thermal expansion coefficient, the deformation portion 1300 in which the first metal 1310 and the second metal 1320 are coupled to each other may be stretched as the temperature increases and may bend to be convex toward the second heater 1220 at the same time.

While the positions of one end and the other end of the fixed deformation portion 1300 do not change and the deformation portion 1300 bends such that the center of the deformation portion 1300 protrudes toward the second heater 1220, the deformation portion 1300 may press the second heater 1220. Depending on the pressing of the deformation portion 1300, the second heater 1220 may move from a first position to a second position.

In the second state, not only the first heater 1210 but also the second heater 1220 may come into contact with the aerosol generating article 2. Accordingly, a portion (e.g., a lower portion of the medium) of the aerosol generating article 2 that comes into contact with the second heater 1220 may also be heated. The area indicated as a ‘heating area’ in FIG. 9B may correspond to an area heated by the first to third heaters 1210, 1220, and 1230.

That is, when a certain time passes after the start of heating, the area of the aerosol generating article 2 that is heated may increase. In this case, the certain time may refer to the time taken for the second heater 1220 to move from the first position to the second position.

As described above, because the center of the medium is heated later than the periphery (e.g., upper and lower portions) of the medium, the entire area of the medium may be prevented from being heated in a short period of time, and thus, the user may inhale a uniform amount of aerosol during the time of using the aerosol generating device.

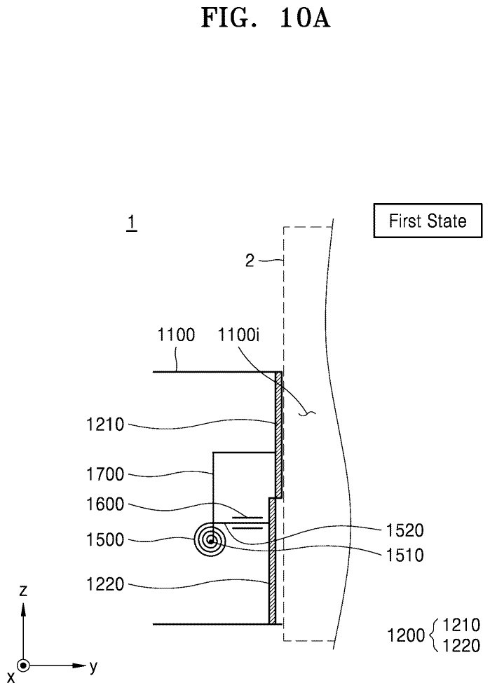

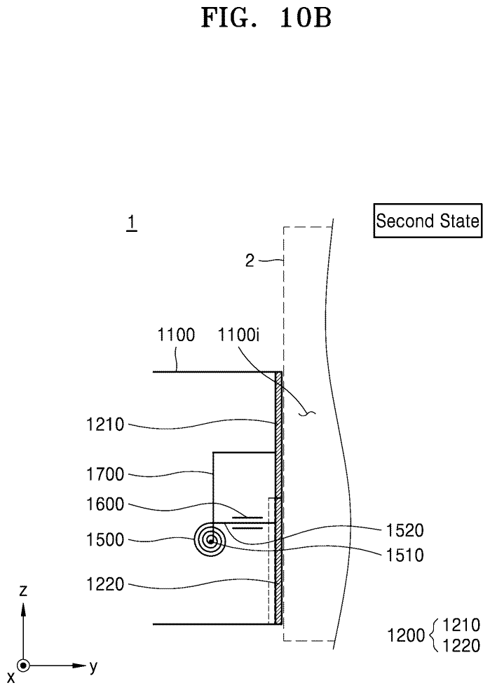

FIG. 10A is a cross-sectional view showing a first state of an aerosol generating device to which a different type of deformation portion is applied compared to FIG. 8A. FIG. 10B is a cross-sectional view showing a second state of the aerosol generating device of FIG. 10A.

Referring to FIGS. 10A and 10B, an aerosol generating device 1 according to an embodiment may include a housing 1100, a heater 1200, and a deformation portion 1500.

At least one of the components of the aerosol generating device 1 illustrated in FIGS. 10A and 10B may be identical or similar to at least one of the components of the aerosol generating device 1 illustrated in FIGS. 8A and 8B, and any duplicate description will be omitted below.

Unlike the aforementioned deformation portion (e.g., the deformation portion 1300 of FIG. 8A) that includes a rod shape, the deformation portion 1500 illustrated in FIGS. 10A and 10B may include a plate-shaped coil shape.

In this case, it is assumed that one end 1510 of the deformation portion 1500 is located at a center portion of the plate-shaped coil and the other end 1520 of the deformation portion 1500 is located at a portion extending in a tangential direction from the edge of the plate-shaped coil. One end 1510 of the deformation portion 1500 may be fixed to the housing 1100 or a component placed inside the housing 1100, and the other end 1520 of the deformation portion 1500 may be connected to a portion of the second heater 1220.

During the change from the first state to the second state, the deformation portion 1500 whose temperature is increased by the second heater 1220 may be deformed so that the other end 1520 that is not fixed extends. As illustrated in FIGS. 10A and 10B, as the temperature of the deformation portion 1500 increases, the other end 1520 of the deformation portion 1500 may extend to be long toward the insertion space 1100i.

As the position of one end 1510 of the fixed deformation portion 1500 does not change and the other end 1520 of the deformation portion 1500 extends toward the insertion space 1100i, the deformation portion 1500 may press the second heater 1220 connected to the other end 1520 of the deformation portion 1500 so that the second heater 1220 moves toward the insertion space 1100i. Depending on the pressing of the deformation portion 1500, the second heater 1220 may move from a first position to a second position.

The other end 1520 of the extending deformation portion 1500 may not straightly extend but may bend along a coil shape. Accordingly, the other end 1520 of the extending deformation portion 1500 may not press the second heater 1220 toward the insertion space 1100i.

To solve this problem, the aerosol generating device 1 according to an embodiment may further include a guide portion 1600. The guide portion 1600 may support the deformation portion 1500 so that the other end 1520 of the deformation portion 1500 may extend in one direction toward the insertion space 1100i. Because the deformation portion 1500 extends in only one direction by the guide portion 1600, the second heater 1220 may be effectively pressed toward the insertion space 1100i.

In addition, the aerosol generating device 1 according to an embodiment may further include a connection portion 1700. The connection portion 1700 is configured to connect the first heater 1210 to one end 1510 of the deformation portion 1500 so that heat generated from the first heater 1210 is transferred to the deformation portion 1500. One end 1510 of the deformation portion 1500 may be connected to the first heater 1210 through the connection portion 1700, and the other end 1520 of the deformation portion 1500 may be connected to the connection portion 1700. Accordingly, not only the heat generated from the second heater 1220 but also the heat generated from the first heater 1210 may be transferred to the deformation portion 1500.

Therefore, the temperature of the deformation portion 1500 may rise quickly, and the degree to which the deformation portion 1500 deforms per unit time may increase. That is, because the other end 1520 of the deformation portion 1500 may extend more quickly, the phenomenon in which the second heater 1220 does not come into contact with the aerosol generating article 2 due to insufficient movement distance of the second heater 1220 during the time that the user uses the aerosol generating device 1 may be prevented. In addition, because the second heater 1220 may move to the extent of pressing the outer surface of the aerosol generating article 2 beyond simply coming into contact with the outer surface of the aerosol generating article 2, the aerosol generating article 2 may be effectively heated by the second heater 1220.

As the use of the aerosol generating device 1 is finished and the temperatures of the heater 1200 and the deformation portion 1500 are lowered, the deformation portion 1500 may change from the shape in the second state to the shape in the first state. That is, the deformation portion 1500 from which the other end 1520 extends may contract again. Accordingly, the second heater 1200 may move from the second position to the first position again.

When the user uses the aerosol generating device 1 again, the deformation portion 1500 may change from the shape in the first state to the shape in the second state, and the second heater 1200 may move from the first position to the second position.

Hereinafter, a case in which an area of the aerosol generating article that is heated changes over time while heating the aerosol generating article will be described.

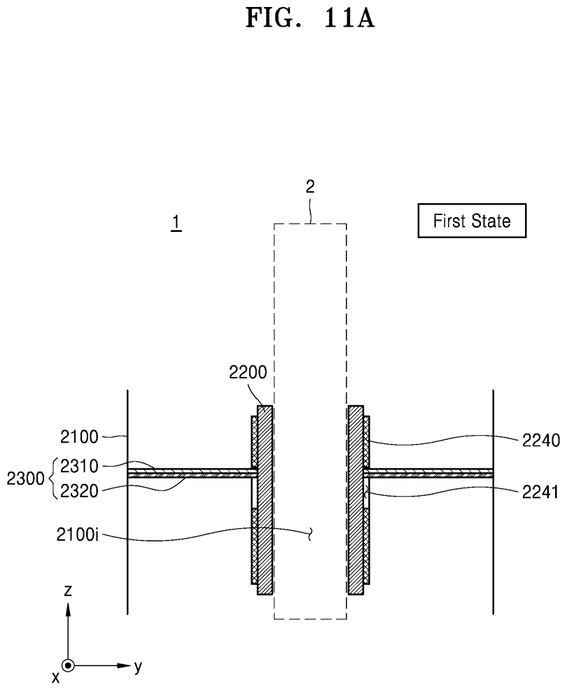

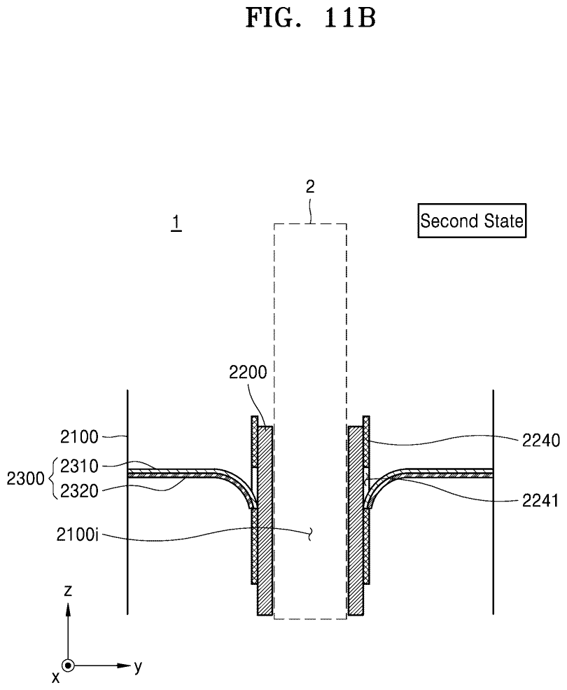

FIG. 11A is a cross-sectional view showing a first state of an aerosol generating device to which a longitudinally movable heater is applied. FIG. 11B is a cross-sectional view showing a second state of the aerosol generating device of FIG. 11A.

Referring to FIGS. 11A and 11B, an aerosol generating device 1 according to another embodiment may include a housing 2100, a heater 2200, and a deformation portion 2300.

At least one of the components of the aerosol generating device 1 illustrated in FIGS. 11A and 11B may be identical or similar to at least one of the components of the aerosol generating device 1 illustrated in FIGS. 7A and 7B, and any duplicate description will be omitted below.

The heater 2200 may move depending on the temperature. Specifically, the heater 2200 may move by the deformation portion 2300 whose shape changes depending on the temperature of the heater 2200.

One end of the deformation portion 2300 may be fixed to the housing 2100 or a component placed inside the housing 2100, and the other end of the deformation portion 2300 may be connected to a portion (e.g., an outer portion) of the heater 2200. Accordingly, as the temperature of the heater 2200 changes, the temperature of the deformation portion 2300 connected to the heater 2200 may also change.

The deformation portion 2300 in which a first metal 2310 having a large thermal expansion coefficient and a second metal 2320 having a small thermal expansion coefficient are coupled to each other may be straightened in the first state. During the change from the first state to the second state, the deformation portion 2300 whose temperature increases may bend. Because the thermal expansion coefficient of the first metal 2310 is greater than the thermal expansion coefficient of the second metal 2320, the deformation portion 2300 may bend in a direction in which the first metal 2310 faces the second metal 2320.

Depending on the deformation of the deformation portion 2300 due to a change in temperature, the heater 2200 may move, and thus, the portion of the aerosol generating article 2 that is heated may change. Specifically, as the temperature of the deformation portion 2300 increases by the heater 2200, the deformation portion 2300 may be stretched and bend downward at the same time. While the position of one end of the fixed deformation portion 2300 does not change and the other end of the deformation portion 2300 bends downward, the heater 2200 connected to the deformation portion 2300 may move in a longitudinal direction (e.g., the z-axis direction) of the heater 2200 due to the deformation of the deformation portion 2300. As the heater 2200 moves, an area of an aerosol generating article 2 that is heated may change.

As the first state changes to the second state, the heater 2200 may move, by the deformation portion 2300, toward a lower portion (e.g., in the -z direction) of an insertion space 2100i. Accordingly, the area of the aerosol generating article 2 that is heated may also move from an upper portion to a lower portion of the medium. Because the lower portion of the medium is heated later than the upper portion of the medium, the entire area of the medium may be prevented from being heated in a short period of time, and thus, the user may inhale a uniform amount of aerosol during the time of using the aerosol generating device.

When the use of the aerosol generating device 1 is finished and the temperatures of the heater 2200 and the deformation portion 2300 are lowered, the deformation portion 2300 may change from the shape in the second state to the shape in the first state. That is, the deformation portion 2300 that was bent while being stretched may be straightened again by shrinking. Accordingly, the heater 2200 may move toward an upper portion of the insertion space 2100i.

When the user uses the aerosol generating device 1 again, the deformation portion 2300 may change from the shape in the first state to the shape in the second state, and the heater 2200 may move toward a lower portion of the insertion space 2100i.

The aerosol generating device 1 according to another embodiment may further include a support portion 2400 that supports the outer portion of the heater 2200 so that the heater 2200 may move only in the longitudinal direction.

The support portion 2400 may include a guide hole 2410 for connecting the deformation portion 2300 to the heater 2200. The guide hole 2410 may allow the deformation portion 2300 to pass through. The other end of the deformation portion 2300 may pass through the support portion 2400 through the guide hole 2410 and be connected to the outer portion of the heater 2200.

The guide hole 2410 may extend in the longitudinal direction (e.g., in the z-axis direction) of the heater 2200. Because the deformation portion 2300 is deformed only in the longitudinal direction of the heater 2200 via the guide hole 2410, the heater 2200 may be effectively moved toward upper and lower portions of the insertion space 2100i.

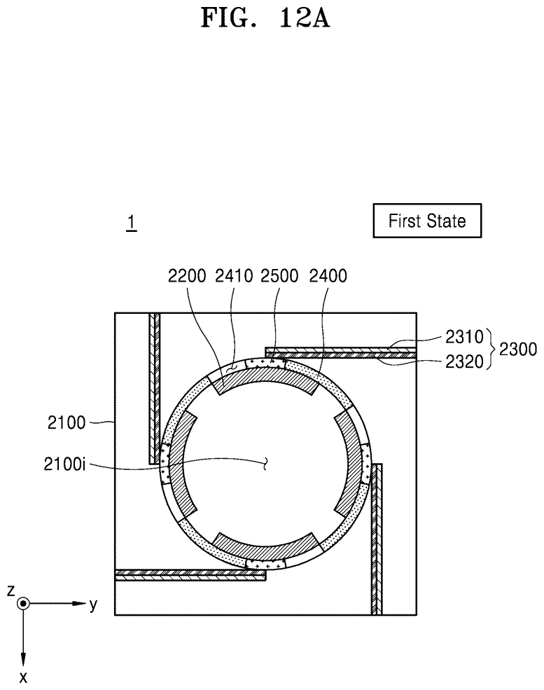

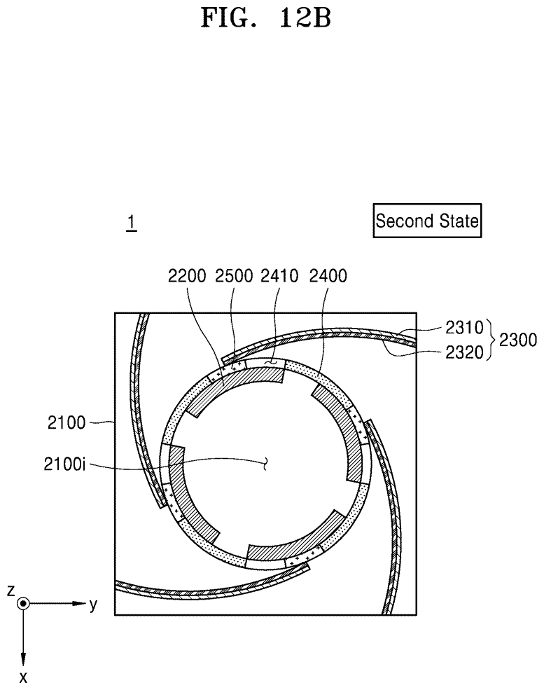

FIG. 12A is a cross-sectional view showing a first state of an aerosol generating device to which a circumferentially movable heater is applied. FIG. 12B is a cross-sectional view showing a second state of the aerosol generating device of FIG. 12A.

Referring to FIGS. 12A and 12B, an aerosol generating device 1 according to another embodiment may include a housing 2100, a heater 2200, a deformation portion 2300, a support portion 2400, and a protrusion portion 2500.

At least one of the components of the aerosol generating device 1 shown in FIGS. 12A and 12B may be identical or similar to at least one of the components of the aerosol generating device 1 shown in FIGS. 11A and 11B, and any duplicate description will be omitted below.

As in the description given with reference to FIGS. 11A and 11B, the heater 2200 may move depending on the deformation of the deformation portion 2300 due to a temperature change, and thus, an area of an aerosol generating article 2 that is heated may change.

Specifically, as the temperature of the deformation portion 2300 increases by the heater 2200, the deformation portion 2300 may be stretched and bend toward an insertion space 2100i at the same time. While the position of one end of the fixed deformation portion 2300 does not change and the other end of the deformation portion 2300 bends toward the insertion space 2100i, the heater 2200 connected to the deformation portion 2300 may move in a circumferential direction of the heater 2200 due to the deformation of the deformation portion 2300. As the heater 2200 moves, an area of the aerosol generating article 2 that is heated may change.

As the first state changes to the second state, the heater 2200 may move, by the deformation portion 2300, in a circumferential direction of the insertion space 2100i. Accordingly, the area of the aerosol generating article 2 that is heated may also move along the circumference of the aerosol generating article 2. That is, in the aerosol generating article 2, because a portion that comes into contact with the heater 2200 after the heater 2200 moves is heated later than a portion that comes into contact with the heater 2200 before the heater 2200 moves, the entire area of the medium may be prevented from being heated in a short period of time, and thus, the user may inhale a uniform amount of aerosol during the time of using the aerosol generating device.

When the use of the aerosol generating device 1 is finished and the temperatures of the heater 2200 and the deformation portion 2300 are lowered, the deformation portion 2300 may change from the shape in the second state to the shape in the first state. That is, the deformation portion 2300 that was bent while being stretched may be straightened again by shrinking. Accordingly, the heater 2200 may move in a direction opposite to a direction in which the heater 2200 moved.

When the user uses the aerosol generating device 1 again, the deformation portion 2300 may change from the shape in the first state to the shape in the second state, and the heater 2200 may move along the circumference of the insertion space 2100i.

The support portion 2400 is configured to support an outer portion of the heater 2200 so that the heater 2200 may move only in the circumferential direction. The support portion 2400 may include a guide hole 2410 for connecting the deformation portion 2300 to the heater 2200. As illustrated in FIGS. 12A and 12B, the deformation portion 2300 and the heater 2200 may be connected to each other through the protrusion portion 2500.

The protrusion portion 2500 is configured to protrude from the outer surface of the heater 2200 and engage with the guide hole 2410. For example, the protrusion portion 2500 may be inserted into the guide hole 2410 or may pass through the guide hole 2410. Because the protrusion portion 2500 moves while engaging with the guide hole 2410, the heater 2200 may move along the support portion 2400 without being separated from the support portion 2400. Therefore, the heater 2200 may move only in the circumferential direction of the heater 2200 or the insertion space 2100i.

One end of the deformation portion 2300 may be fixed to the housing 2100 or a component arranged inside the housing 2100, and the other end of the deformation portion 2300 may be connected to the protrusion portion 2500 engaging with the guide hole 2410. That is, the other end of the deformation portion 2300 may be connected to the outer portion of the heater 2200 through the protrusion portion 2500.

The guide hole 2410 may extend in the circumferential direction of the heater 2200 or in the circumferential direction of the insertion space 2100i. Because the deformation portion 2300 is deformed only in the circumferential direction of the heater 2200 via the guide hole 2410, the heater 2200 may be effectively moved in the circumferential direction of the heater 2200 or the insertion space 2100i.

Hereinafter, a case in which the number of heaters to which power is supplied while heating an aerosol generating article gradually increases will be described.

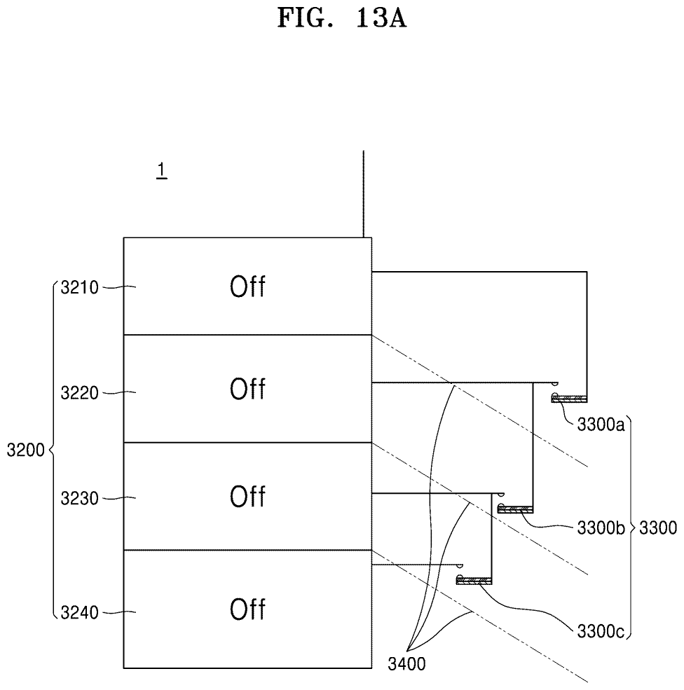

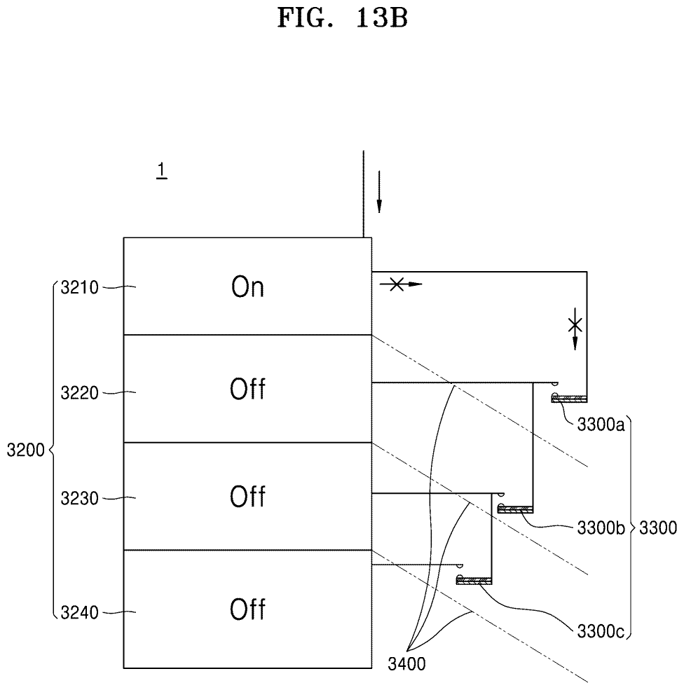

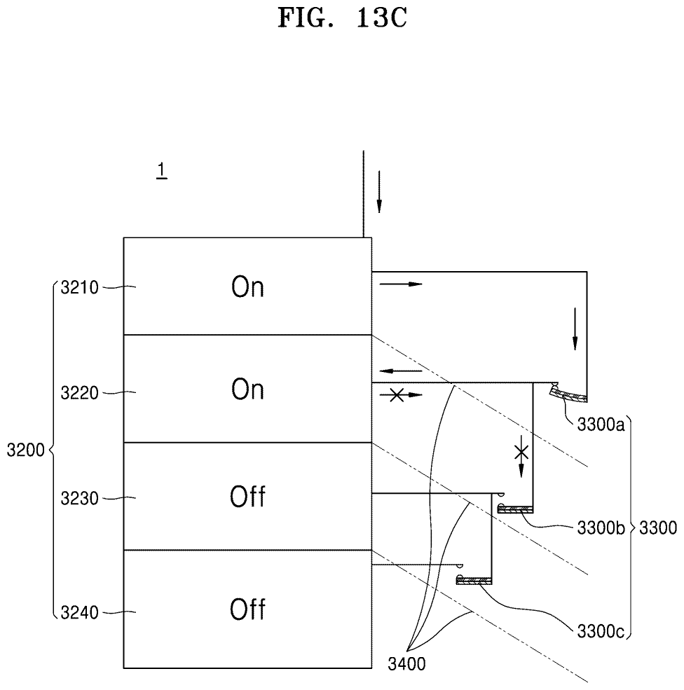

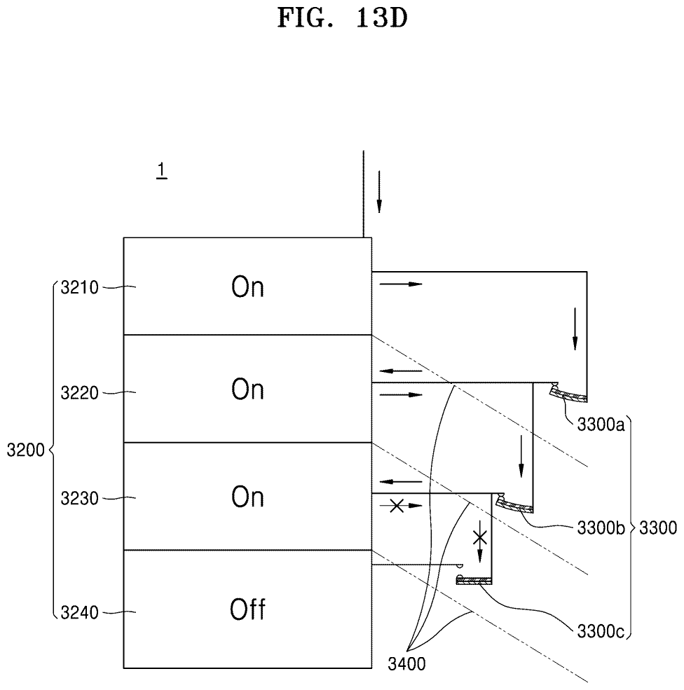

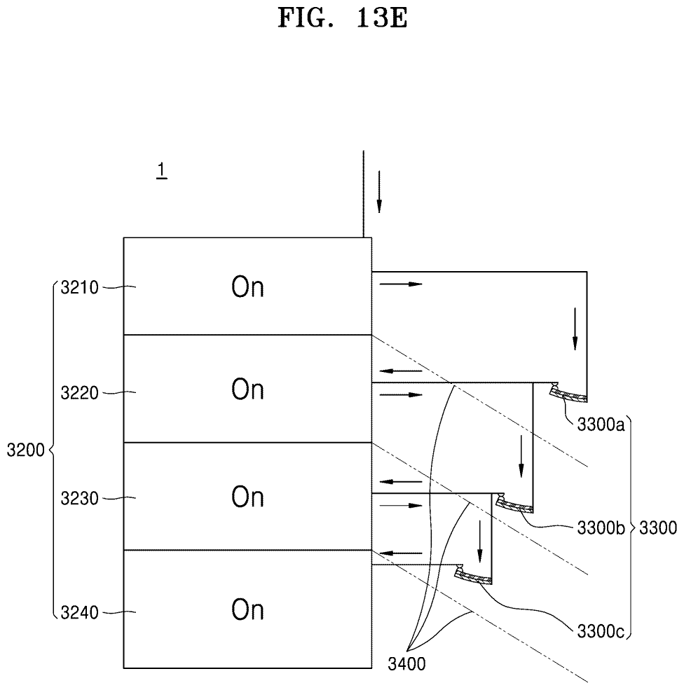

FIGS. 13A to 13E are views schematically illustrating an aerosol generating device to which a plurality of heaters that are sequentially activated are applied.

Referring to FIGS. 13A to 13E, an aerosol generating device 1 according to another embodiment may include a plurality of heaters 3200 and one or more deformation portions 3300.

At least one of the components of the aerosol generating device 1 illustrated in FIGS. 13A to 13E may be identical or similar to at least one of the components of the aerosol generating device 1 illustrated in FIGS. 7A and 7B, and any duplicate description will be omitted below.

The deformation portion 3300 may function as a switch, which operates the heater 3200, by deforming in response to a temperature change caused by the heater 3200. In this case, because the deformation portion 3300 is deformed by heat generated by the heater 3200, the deformation portion 3300 may function as a ‘thermal switch’.

The deformation portion 3300 deformed by one heater 3200 may enable power to be supplied to another heater 3200. Accordingly, the plurality of heaters 3200 may be sequentially activated after heating starts.

As illustrated in FIGS. 13A to 13E, four heaters 3200 may be arranged. That is, the heaters 3200 may include a first heater 3210, a second heater 3220, a third heater 3230, and a fourth heater 3240. Three deformation portions 3300 may be arranged. That is, the deformation portions 3300 may include a first deformation portion 3300a, a second deformation portion 3300b, and a third deformation portion 3300c. However, the embodiment is not limited to the number of heaters 3200 and deformation portions 3300 illustrated.

Referring to FIG. 13A, an appearance in which not all heaters 3200 are activated is illustrated. That is, the state illustrated in FIG. 13A is a state in which no power is supplied to all heaters 3200.

In this case, among the four heaters 3200, only the first heater 3210 is connected to a power source or a controller. The second heater 3220 may be connected to the first heater 3210 through the first deformation portion 3300a. The third heater 3230 may be connected to the second heater 3220 through the second deformation portion 3300b. The fourth heater 3240 may be connected to the third heater 3230 through the third deformation portion 3300c. That is, two heaters 3200 may be connected to each other by one deformation portion 3300. Accordingly, the deformation portion 3300 may be arranged one less than the heater 3200.

However, before the deformation portion 3300 is deformed by heat, for example, when the deformation portion 3300 is straightened as illustrated, the two heaters 3200 are not electrically connected to each other. When the deformation portion 3300 is deformed by heat and bend, the two heaters 3200 may be electrically connected to each other. Accordingly, power may be supplied from one heater 3200, to which power is already supplied, to another heater 3200.

Referring to FIG. 13B, the first heater 3210 may receive power from a power source by the controller. The first heater 3210 to which power is supplied may be activated and generate heat. The heat generated from the first heater 3210 may deform the first deformation portion 3300a. However, in FIG. 13B, because not enough time has passed since the first heater 3210 was heated, the first deformation portion 3300a is illustrated as not being deformed.

In a state in which the first deformation portion 3300a is not bent, the first heater 3210 and the second heater 3220 are not electrically connected to each other and are open. Accordingly, no power is supplied from the first heater 3210 to the second heater 3220. In addition, no current flows from the first heater 3210 to the first deformation portion 3300a.

Referring to FIG. 13C, the first deformation portion 3300a may be deformed by the heat generated from the first heater 3210. Specifically, the temperature of the first deformation portion 3300a may change in response to a change in the temperature of the first heater 3210, and accordingly, the first deformation portion 3300a may be deformed.

As illustrated in the drawings, the first deformation portion 3300a may be arranged to be spaced apart from the first heater 3210. Accordingly, the heat generated from the first heater 3210 may spread to a space between the first deformation portion 3300a and the first heater 3210, and thus may be transferred to the first deformation portion 3300a.

However, the embodiment is not limited thereto. As another example, the first deformation portion 3300a may be directly connected to the first heater 3210, and thus, the heat generated from the first heater 3210 may be directly transferred to the first deformation portion 3300a. As another example, a temperature sensor (not shown) may monitor the temperature of the first heater 3210, and a controller may supply power to the first deformation portion 3300a in response to a change in the temperature of the first heater 3210 to heat the first deformation portion 3300a.

The relationship between the first heater 3210 and the first deformation portion 3300a, described above may be equally applied between the second heater 3220 and the second deformation portion 3300b and between the third heater 3230 and the third deformation portion 3300c.

The first deformation portion 3300a may function as a switch that activates the second heater 3220. When the first deformation portion 3300a is bent by heat, the first heater 3210, the first deformation portion 3300a, and the second heater 3220 may be electrically connected to each other. Accordingly, power may be supplied from the first heater 3210 to the second heater 3220.

The second heater 3220 supplied with power may be activated to generate heat. The heat generated from the second heater 3220 may deform the second deformation portion 3300b. However, in FIG. 13C, because not enough time has passed since the second heater 3220 was heated, the second deformation portion 3300b is illustrated as not being deformed.

In a state where the second deformation portion 3300b is not bent, the second heater 3220 and the third heater 3230 are not electrically connected to each other and are open. Accordingly, no power is supplied from the second heater 3220 to the third heater 3230. In addition, no current flows from the second heater 3220 to the second deformation portion 3300b.

Referring to FIG. 13D, the second deformation portion 3300b may be deformed by the heat generated from the second heater 3220. The second deformation portion 3300b may be deformed in response to a change in the temperature of the second heater 3220. Specifically, the temperature of the second deformation portion 3300b may change in response to the temperature of the second heater 3220, and accordingly, the second deformation portion 3300b may be deformed.

The second deformation portion 3300b may function as a switch that activates the third heater 3230. When the second deformation portion 3300b is bent by heat, the second heater 3220, the second deformation portion 3300b, and the third heater 3230 may be electrically connected to each other. Accordingly, power may be supplied from the second heater 3220 to the third heater 3230.

The third heater (3230) supplied with power can be activated to generate heat. The heat generated from the third heater 3230 may deform the third deformation portion 3300c. However, in FIG. 13D, because not enough time has passed since the third heater 3230 was heated, the third deformation portion 3300c is illustrated as not being deformed.

In a state where the third deformation portion 3300c is not bent, the third heater 3230 and the fourth heater 3240 are not electrically connected to each other and are open. Accordingly, power is not supplied from the third heater 3230 to the fourth heater 3240. In addition, no current flows from the third heater 3230 to the third deformation portion 3300c.

Referring to FIG. 13E, the third deformation portion 3300c may be deformed by the heat generated from the third heater 3230. The third deformation portion 3300c may be deformed in response to a change in the temperature of the third heater 3230. Specifically, the temperature of the third deformation portion 3300c may be changed in response to the temperature of the third heater 3230, and accordingly, the third deformation portion 3300c may be deformed.

The third deformation portion 3300c may function as a switch that activates the fourth heater 3240. When the third deformation portion 3300c is bent by heat, the third heater 3230, the third deformation portion 3300c, and the fourth heater 3240 may be electrically connected to each other. Accordingly, power may be supplied from the third heater 3230 to the fourth heater 3240.

The fourth heater 3240 supplied with power may be activated to generate heat. As a result, all heaters 3200 may be sequentially activated. As illustrated in the drawings, one heater 3200 activates its adjacent heater 3200 through the deformation portion 3300, but the embodiment is not necessarily limited thereto. Even when another heater 3200 is physically separated from one heater 3200, when they may be electrically connected to each other through the deformation portion 3300, the other heater 3200 may be activated.

According to an embodiment, because the plurality of heaters 3200 are sequentially activated, the area of the aerosol generating article that is heated may gradually increase, thereby preventing the entire area of a medium from being heated in a short period of time, and thus, the user may inhale a uniform amount of aerosol during the time the aerosol generating device is used.

When the use of the aerosol generating device 1 is finished and the temperatures of the heater 3200 and the deformation portion 3300 are lowered, the deformation portion 3300 that was bent while being stretched may be straightened again by shrinking. Accordingly, a space between the two heaters 3200 that were electrically connected to each other may be electrically opened again.

When the user uses the aerosol generating device 1 again, the deformation portion 3300 may be bent by heat, and the plurality of heaters 3200 may be sequentially activated.

The aerosol generating device 1 according to another embodiment may further include an insulating member 3400. The insulating member 3400 illustrated in the dashed line may prevent heat from being transferred between the heater 3200 and the deformation portion 3300 that are not connected to each other. For example, the insulating member 3400 may block heat transfer, thereby preventing heat generated from the first heater 3210 from being transferred to the second deformation portion 3300b instead of the first deformation portion 3300a.

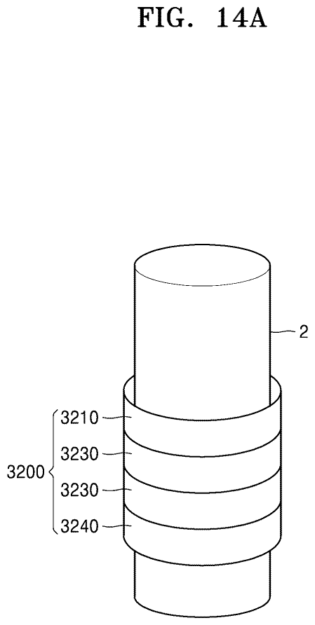

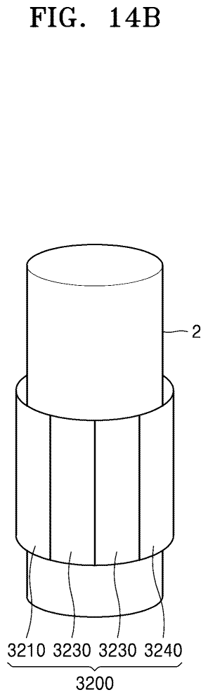

FIGS. 14A and 14B are perspective views each illustrating a plurality of heaters that are sequentially activated.

Referring to FIGS. 14A and 14B, a plurality of heaters 3200 and an aerosol generating article 2 surrounded by the plurality of heaters 3200 are illustrated.

At least one of the components of the heaters 3200 shown in FIGS. 14A and 14B may be identical or similar to at least one of the components of the heaters 3200 shown in FIGS. 13A to 13E, and any duplicate description will be omitted below.

Referring to FIG. 14A, a plurality of heaters 3200 are arranged in a longitudinal direction of the aerosol generating article 2. Because the plurality of heaters 3200 are sequentially activated, the area of the aerosol generating article 2 that is heated gradually increases from the top to the bottom of the aerosol generating article 2, thereby preventing the entire area of a medium from being heated in a short period of time, and thus, the user may inhale a uniform amount of aerosol during the time of using the aerosol generating device.

Referring to FIG. 14B, a plurality of heaters 3200 are arranged in a circumferential direction of the aerosol generating article 2. Because the plurality of heaters 3200 are sequentially activated, the area of the aerosol generating article 2 that is heated gradually increases in the circumferential direction, thereby preventing the entire area of a medium from being heated in a short period of time, and thus, the user may inhale a uniform amount of aerosol during the time of using the aerosol generating device.

According to the aerosol generating device according to embodiments, by applying a deformation portion to a heater, aerosol may be uniformly generated while the user uses the aerosol generating device.

Effects of the present disclosure are not limited to the above effects, and effects that are not mentioned could be clearly understood by one of ordinary skill in the art from the present specification and the attached drawings.

Certain embodiments or other embodiments of the present disclosure described above are not exclusive or distinct from each other. The certain embodiments or other embodiments of the present disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictedly but should be considered illustrative in all aspects. The scope of the present disclosure should be determined by a rational interpretation of the attached claims, and all changes within the equivalent scope of the present disclosure are included in the scope of the present disclosure.

According to the aerosol generating device according to embodiments, aerosol may be uniformly generated while the user uses the aerosol generating device. Accordingly, the user's smoking satisfaction can be increased. Effects of the present disclosure are not limited to the above effects, and effects that are not mentioned could be clearly understood by one of ordinary skill in the art from the present specification and the attached drawings.

What is claimed is:

1. An aerosol generating device comprising:
a housing comprising an insertion space for accommodating an aerosol generating article;
one or more heaters configured to heat the aerosol generating article inserted into the insertion space; and
a deformation portion configured to deform in response to a temperature change caused by the one or more heaters,
wherein heating areas of the one or more heaters for the aerosol generating article vary depending on deformation of the deformation portion.

2. The aerosol generating device of claim 1, wherein the one or more heaters comprise the deformation portion.

3. The aerosol generating device of claim 1, wherein shapes of the one or more heaters vary depending on the deformation of the deformation portion.

4. The aerosol generating device of claim 1, wherein the one or more heaters comprise a fixed first heater and a second heater that is arranged above or under the first heater and movable, and
wherein the second heater is connected to the deformation portion and is movable according to the deformation of the deformation portion.

5. The aerosol generating device of claim 4, wherein the second heater moves between a first position spaced apart from the aerosol generating article accommodated in the insertion space and a second position in contact with the aerosol generating article accommodated in the insertion space.

6. The aerosol generating device of claim 4, further comprising a rail configured to guide movement of the second heater.

7. The aerosol generating device of claim 4, wherein one end of the deformation portion is fixed, another end of the deformation portion is connected to the second heater, and while temperature is increased by the second heater, the deformation portion presses the second heater so that the second heater moves toward the insertion space.

8. The aerosol generating device of claim 7, wherein the deformation portion comprises a plate-shaped coil shape, the aerosol generating device further comprising a connection portion connecting the first heater to the one end of the deformation portion so that heat generated from the first heater is transferred to the deformation portion.

9. The aerosol generating device of claim 4, wherein the one or more heaters comprise a fixed third heater,
the deformation portion is arranged to face the first heater and the third heater,
one end of the deformation portion and another end of the deformation portion are fixed,
the second heater is arranged at a center of the deformation portion between the first heater and the third heater, and
while temperature is increased by the second heater, the deformation portion presses the second heater so that the second heater moves toward the insertion space.

10. The aerosol generating device of claim 1, wherein the one or more heaters moves according to the deformation of the deformation portion, and an area of the aerosol generating article that is heated changes.

11. The aerosol generating device of claim 10, wherein one end of the deformation portion is fixed,
another end of the deformation portion is connected to outer portions of the one or more heaters, and
the one or more heaters are movable in a longitudinal direction or a circumferential direction of the one or more heaters by the deformation of the deformation portion.

12. The aerosol generating device of claim 10, further comprising a support portion configured to support the outer portions of the one or more heaters,
wherein the support portion comprises a guide hole for connecting the deformation portion to the one or more heaters.

13. The aerosol generating device of claim 12, further comprising a protrusion portion configured to protrude from outer surfaces of the one or more heaters and engage with the guide hole,
wherein one end of the deformation portion is fixed, and another end of the deformation portion is connected to the protrusion portion.

14. The aerosol generating device of claim 1, wherein the one or more heaters comprise a first heater and a second heater, and
wherein the deformation portion comprises a first deformation portion that functions as a thermal switch, the first deformation portion being deformed in response to a temperature change caused by the first heater so that power is supplied to the second heater.

15. The aerosol generating device of claim 14, wherein the one or more heaters further comprise a third heater, and
wherein the deformation portion further comprises a second deformation portion that functions as a thermal switch, the second deformation portion being deformed in response to a temperature change caused by the second heater so that power is supplied to the third heater,
the aerosol generating device further comprising an insulating member that prevents heat generated by the first heater from being transferred to the second deformation portion.
